(19) United States
(12) Patent Application Publication
(10) Pub. No.: US 2013/0275429 A1
(43) Pub. Date: Oct. 17, 2013

(54) SYSTEM AND METHOD FOR ENABLING CONTEXTUAL RECOMMENDATIONS AND COLLABORATION WITHIN CONTENT

(71) Applicants: Graham York, Ashmore (GB); Lee Henry Burgess, Kew (GB)

(72) Inventors: Graham York, Ashmore (GB); Lee Henry Burgess, Kew (GB)

(21) Appl. No.: 13/550,599

(22) Filed: Jul. 17, 2012

Related U.S. Application Data
(60) Provisional application No. 61/623,542, filed on Apr. 12, 2012.

(51) Int. Cl. G06F 17/30

(52) U.S. Cl. 707/737; 707/E17.002

(57) ABSTRACT

A system for enabling contextual recommendations and collaboration recommendations, based on a user's current work, comprising a plurality of content collector software applications adapted to interface with a plurality of content management applications, an indexing engine software application, an expanded social network graph database, and a predictive content intelligence software application. The plurality of content collector software applications receive documents, document fragments, or other content objects from the plurality of content management applications, the indexing engine software application indexes the retrieved documents, document fragments, or other content objects and modifies the expanded social network graph database using results of the indexing, and the predictive content intelligence software application, using at least the results of the indexing and the expanded social network graph database, identifies at least a plurality of other content objects and a plurality of people that are relevant to the received documents, document fragments, or other content objects.

### CROSS-REFERENCE TO RELATED APPLICATIONS

This application claims priority to U.S. provisional patent application Ser. No. 61/623,542, titled “SYSTEM AND METHOD FOR ENABLING CONTEXTUAL RECOMMENDATIONS AND COLLABORATION WITH CONTENT,” which was filed on Apr. 12, 2012, the entire of specification of which is incorporated herein by reference.

### BACKGROUND OF THE INVENTION

1. Field of the Invention

The invention relates to the field of content management, and more particularly to the field of providing context-based, relevant recommendations to users of content while they interact with the content, and enabling context-based collaboration between content users.

2. Discussion of the State of the Art

Despite its ubiquity today, widespread adoption of word processing applications and the documents they create has only occurred in the last twenty years. Similarly, the adoption of email has advanced extremely rapidly in the last fifteen years, and even more recently new document or message types such as instant messages, blogging and microblogging, and social network page updates have emerged. In each of these cases of the emergence of new message types, the new message type has largely been additive to existing message types, in that while the new message type may exhibit dramatic and rapid growth in message volumes, in most cases this growth is in addition to, rather than instead of, growth in traffic of previously-established message types. Furthermore, many new types of content are being made available in electronic form, including for example podcasts, streaming or file-oriented audio and visual content, transcriptions of phone calls, microblogging posts, and so forth, many of which can be at least partly converted to text, either automatically or with human transcription assistance.

Thus, while twenty-five years ago relatively few people led lives in which their work or play exposed them to a steady stream of text-based electronic documents, messages, and other content from wide ranges of people (and on wide ranges of topics), today even young children are often proficient with text messaging and the web, and all students are taught to use word processors, spreadsheets, and presentation software as basic elements of modern life. And essentially every working person in the developed world (and an increasingly large percentage of those in less-developed countries) deals every day with emails as a new (in a historical sense) but essential element of his work. As a result, people today handle many electronic documents, messages, and other content every day, resulting in new challenges of complexity and multitasking for people's work and personal lives. This phenomenon is accelerating as well, particularly with the rapid rise of social networks such as Facebook™ and microblogging services such as Twitter™. This massive growth in quantity and range of electronic messages, documents, and other content handled by basically everyone is fundamentally a new historical condition for humans.

What there has been less of, so far, is serious focus on practical solutions to the problem of information overload. It is increasingly difficult for individuals to digest the mass of textual information that is presented to them each day. The problem is not just because of the ever-increasing volume and variety of textual content items that are handled by individuals each day, but also because people are more connected than ever before (social networks), more informed (the web), more engaged (blogging, Twitter™, and social networks), and more multitasked, with the boundaries between work and play, and between family life and professional life becoming steadily more blurred. Because of these challenges, it is quite common when a person opens an email or a Word document, or when they view “tweets” on Twitter™, that the person must execute a “context shift”, moving for example directly from a client call to viewing a tweet from a relative and then to skimming a blog or two about a favorite subject. Considering for a moment just the work side of this problem, employees in businesses are typically connected to far more people today than ever before, with communications flowing freely within and between large corporations and large numbers of “free agents” (freelancers such as consultants, accountants, marketing professionals, legal professionals, and so forth), employees often receive more than a hundred emails per day (consider that this translates to at least one every five minutes during a typical workday), many of which involve topics or people with whom the employees are only tangentially involved. A person trying to put together a proposal for a major deal might have to contend with incoming text messages, emails, phone calls, and streams of tweets and other evanescent text objects, each of which tends to pull the person off her intended task, and each of which might require some mental effort to understand and reply to (since the senders and subjects of such messages are commonly very diverse).

Moreover, people are less likely to work in rigidly structured organizational divisions, or to work only within “silos” of knowledge. Rather, thanks to mergers, acquisitions, and complex “matrixed” organizational structures, knowledge and expertise tend to be diffusely spread across organizational boundaries and geographies, and it is often difficult to identify or locate relevant people who can assist with a given task. Additionally, when key people leave organizations, their knowledge—and particularly their informal knowledge of organizational context—is usually lost, and only unstructured data is left behind in abandoned presentations and other documents. This probably is exacerbated by a generally increase in use of consultants and other non-employees, with the result that corporations have a great need for a modern “corporate memory”.

In the art, there have been efforts made to provide some context for emails, for example by a company known as Xobni™, whose product provides a list of people, and certain key information items about those people, who are considered relevant to a particular email (because they were a sender or a recipient of the email, or because they have been part of a related email thread, or because they are organizationally responsible for the subject of the email. Similarly, Google™, in its online email application known as Gmail™, will sometimes use the presence of known search terms in an email to suggest individuals (typically who are known contacts of the email reader and who have used those search terms frequently) who might be appropriate recipients of the email. While these products, and others like them, do serve a useful purpose, they are focused exclusively on the “people” aspect of the problem (Xobni™, for example, refers to its product as “your smarter address book”), and they generally focus on narrow ranges of content types (e.g., emails).

What is needed in the art is a system that is able to combine knowledge about people, information about any relevant domains of knowledge, and information about a large number of documents and other content objects that might be relevant or of use to a person interacting with a content object (including information pertaining to the contents of the documents, messages, or content items), all of which together can be used to identify not only people but also documents and other content objects that might be relevant or useful to a person viewing, responding to, or creating a document such as an email. Such a system (and associated methods) is needed to provide context-based and relevant recommendations to users while they interact with a content object, to enable context-aware collaboration between users of a document or between individuals interacting with a specific content object, and to institute a more comprehensive “corporate memory”.

### SUMMARY OF THE INVENTION

Accordingly, in a preferred embodiment the invention provides a system for enabling contextual recommendations and collaboration recommendations, based on a user's current work. According to the embodiment, a large amount of content objects are analyzed and indexed, and metadata pertaining to these content objects is stored along with information about people and their relationships in an enhanced social network graph, in which content objects and people may be nodes in the graph, and their relationships may be edges in the graph. The enhanced social network graph also comprises nodes consisting of ontologies, topics, or domain models, and relationships between people and topics, or between people and content objects, or between content objects and topics may therefore be captured in an enhanced social network graph. The inventors conceived a solution to the problem of information overload (and context “underload”) based on this notion of a richer social network graph, in which recommendations of people and content objects that might be relevant to a person handling a particular document can be made to that person effectively in real time, in order that the person's handling of the content object in question may thereby be facilitated beyond what is possible by merely providing a list of persons who might be of help.

According to a preferred embodiment of the invention, a system for enabling contextual recommendations and collaboration recommendations, based on a user's current work, comprising a plurality of content collector software applications adapted to interface with a plurality of content management applications, an indexing engine software application, an expanded social network graph database, and a predictive content intelligence software application is disclosed. According to the embodiment, the plurality of content collector software applications receive documents, document fragments, or other content objects from the plurality of content management applications, the indexing engine software application indexes the retrieved documents, document fragments, or other content objects and modifies the expanded social network graph database using results of the indexing, and the predictive content intelligence software application, using at least the results of the indexing and the expanded social network graph database, identifies at least a plurality of other content objects and a plurality of people that are relevant to the received documents, document fragments, or other content objects.

According to another embodiment of the invention, the predictive content intelligence software application comprises at least an ontology engine. In another embodiment, the predictive content intelligence software application comprises at least a relevance engine. In yet another embodiment, the predictive content intelligence software application comprises at least an ontology engine and a relevance engine.

According to a further embodiment of the invention, a content collector software application comprises an email interface. In a further embodiment, the email interface is adapted to send identities of or links to the relevant content objects and people to an email client software application as recommendations for use by a user of the email client software application.

According to another embodiment of the invention, the predictive content intelligence software application is further adapted to receive via a data network search queries from users, and to provide, in response to the search queries, search results comprising identities of or links to the relevant content objects and people.

According to another embodiment of the invention, an active intelligent content storage server system adapted to determine when a retrieved document, document fragment, or other content object is unmanaged and to thereupon store the unmanaged documents, document fragments, or other content objects such that they may later be reliably retrieved using index information stored in the expanded social network graph database.

According to another embodiment of the invention, the indexing engine stores a temporary graph fragment comprising index information derived from a newly-created content fragment, the predictive content intelligence engine identifies at least a plurality of other content objects and a plurality of people that are relevant based on the temporary graph fragment, and the indexing engine and the predictive content intelligence engine iteratively update the temporary graph and the plurality of relevant other content objects and people as the newly-created content fragment is edited, and when editing of the newly-created content fragment is completed, the temporary graph fragment is added to the expanded social network graph database.

In a preferred embodiment of the invention, a method for enabling contextual recommendations and collaboration within a content item, the method comprising the steps of: (a) receiving, using a content collector software application coupled to a data network, a document, document fragment, or other content object; (b) indexing the document, document fragment, or other content object using an indexing engine software application coupled to a data network; (c) modifying an expanded social network graph database using results of the indexing; and (d) identifying, using a predictive content intelligence engine software application coupled to a data network and the results of the indexing, at least a plurality of other content objects and a plurality of people, the pluralities of other content objects and people relevant to the retrieved document, document fragment, or other content object., is disclosed.

In another embodiment, the invention further comprises the steps of (a1) determining, using an active intelligent content storage server system, if the received document, document fragment, or other content object is unmanaged; and (a2) if the received document, document fragment, or other content object is unmanaged, storing the unmanaged document, document fragment, or other content object such that it may later be reliably retrieved using index information stored in the expanded social network graph database.

In another preferred embodiment of the invention, a method for enabling contextual recommendations and collaboration within a content object, the method comprising the steps of: (a) receiving, using a plurality of content collector software applications coupled to a data network, a plurality of documents, document fragments, or other content objects; (b) indexing the documents, document fragments, or other content objects using an indexing engine software application coupled to a data network; (c) modifying an expanded social network graph database using results of the indexing; (d) receiving, at a predictive content intelligence engine coupled to a data network, a search query from a user; (e) identifying, using a predictive content intelligence engine software application coupled to a data network and the results of the indexing, at least a plurality of content objects and a plurality of people, the pluralities of content objects and people relevant to the search query; and (f) providing, in response to the search query, search results comprising identities of or links to the relevant content objects and people, is disclosed.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating a conceptual architecture of a preferred embodiment of the invention.

FIG. 2 is a block diagram illustrating an exemplary arrangement of content collection and analysis components, according to a preferred embodiment of the invention.

FIG. 3 is a block diagram illustrating an exemplary arrangement of predictive content intelligence and user interface components, according to a preferred embodiment of the invention.

FIG. 4 is a block diagram illustrating a system landscape showing an exemplary physical arrangement of components, according to an embodiment of the invention.

FIG. 5 is a block diagram showing relationships among various logical entities, according to an embodiment of the invention.

FIG. 6 is a diagram showing an expanded social network graph, according to an embodiment of the invention.

FIG. 7 is a process flow diagram illustrating a process for active security management, according to an embodiment of the invention.

FIG. 8 is an illustration of an exemplary arrangement of information flows, according to an embodiment of the invention.

FIG. 9 is a process flow diagram illustrating handling of an inbound email, according to a preferred embodiment of the invention.

FIG. 10 is a process flow diagram illustrating handling of an outbound email, according to a preferred embodiment of the invention.

FIG. 11 is a process flow diagram of a method for managing adaptive contexts, according to a preferred embodiment of the invention.

FIG. 12 is an illustration of an exemplary document plugin interface, according to a preferred embodiment of the invention.

FIG. 13 is an illustration of a further exemplary content plugin interface, according to a preferred embodiment of the invention.

FIG. 14 is an illustration of a further exemplary content plugin interface, according to a preferred embodiment of the invention.

FIG. 15 is an illustration of an exemplary visualization interface for use by a client, according to an embodiment of the invention.

FIG. 16 is an illustration of a summary style user interface view, according to an embodiment of the invention.

FIG. 17 is a block diagram illustrating an exemplary hardware architecture of a computing device used in an embodiment of the invention.

FIG. 18 is a block diagram illustrating an exemplary logical architecture for a client device, according to an embodiment of the invention.

FIG. 19 is a block diagram showing an exemplary architectural arrangement of clients, servers, and external services, according to an embodiment of the invention.

### DETAILED DESCRIPTION

The inventor has conceived, and reduced to practice, a system and various methods for enabling contextual recommendations and collaboration recommendations, based on a user's current work. Various techniques will now be described in detail with reference to a few example embodiments thereof, as illustrated in the accompanying drawings. In the following description, numerous specific details are set forth in order to provide a thorough understanding of one or more aspects and/or features described or referenced herein. However, it will be apparent to one skilled in the art, that one or more aspects and/or features described or referenced herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified other wise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Furthermore, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

Although described within the context of email or document management technology, it may be understood that the various aspects and techniques described herein (such as those associated with enhanced social network graphs, for example) may also be deployed and/or applied in other fields of technology involving delivery in real-time or near real-time of intelligent context-based recommendations.

### Definitions

“Content object” as used herein means any electronic unit of content such as documents, messages (emails, chat messages, text messages, and the like), microblogging posts (Twitter posts, and so forth), transcribed audio content, or even non-textual content such as audio or video content that is adapted for indexing either by inclusion of metadata or tagging data, or by direct analysis of the media itself (that is, analysis of the actual raw audio or video content).

“Document” as used herein means any electronic text-based content object and intended or at least appropriate for opening, reading, writing, reviewing, and the like by one or more human users. “Electronic” in the above definition means that a document, as used herein, is capable of being interacted with by a human using one or more of a personal computer, a laptop, a smart phone or other text-capable telephony device, a tablet computing device such as an Apple iPad™, or any other device comprising at least a processor, a memory, and a user interface element suitable for displaying or presenting text-based materials. Examples of documents include, but are not limited to, emails, text messages (e.g., messages such as short message service (SMS) messages, instant messages or chats using for example the extensible messaging and presence protocol XMPP, “tweets” on the Twitter™ platform, blog posts, web pages, spreadsheets, Word™ and other word processing files, presentations, portable document format (PDF) files, and the like. In some examples provided herein, reference may be made to emails or Word™ documents for particular exemplary descriptions of embodiments of the invention. It will be appreciated by one having ordinary skill in the art of electronic documents that in each of these cases, a narrower example such as email is used for clarity, and is not to be taken as in any way limiting the scope of the invention, which applies to any and all forms of electronic documents. As used herein, “document” should always be interpreted to mean “document or other content object”, unless the context of a given usage is clearly limited only to text-based documents.

A “graph”, as used herein, is an instance of a mathematical or data object that comprises “nodes” and “edges”, such that each edge connects two nodes, and each node is connected via at least one edge to at least one other node (it is theoretically possible in mathematics to have a graph node with no edges and therefore no connections to any other nodes, but such nodes are likely to be few and evanescent in systems according to the invention). Graph edges can be undirected (that is, they can operate bidirectionally, pointing from either end to the other end), or directed (that is, they point only from one end to the other end). Edges can optionally be given weights to indicate relative or absolute strengths of connections between nodes, and they may be assigned attributes that are taken to characterize one or more specific qualities of the connections they represent. A “path” in a graph is a sequence of edge traversals (that is, “movements” from one node to a next node along an edge connecting the nodes) that have a start (a first node) and an end (a last node). A “subgraph” is a graph that comprises a subset of nodes and edges of a graph of which it is a subgraph. A graph is a subgraph of itself, just as a set is a subset of itself.

A “social network graph”, as used herein, is a graph according to which nodes represent people, and edges represent “connections”, or relationships, between people, such as occur in the well-known “six degrees of separation” metaphor (which effectively states a hypothesis concerning properties of a “universal social network graph” that represents all connections between individuals in the world (if they were knowable, which is usually not the case)—specifically that any two nodes (people) are likely to be connected by at least one path having length less than or equal to six. Connections may be of many kinds and strengths. For instance, a parent-child connection is one kind of connection, and usually (but not always) a connection that has considerable weight when evaluating a random person's social network. Other common connection types include employer-employee relationships, friendships, perpetrator-victim relationships (not all connections need be voluntary or positive), electronic social network friendships, professional networking connections, and so forth. Social network graphs may be, but need not be, stored electronically (although embodiments of the present invention use electronic social network graphs stored in databases of one kind or another, and do not use abstract social network graphs (such as the graph that loosely connects all humans, including those who have heretofore left no digital trace of their existence whatsoever).

An “expanded social network graph”, as used herein, is a social network graph in which nodes can represent objects (using this term in its broadest sense) of many types, rather than only “human objects” (it should be understood from the foregoing definition of a social network graph that they are taken herein to refer only to social networks comprising people, and by extension groups of people—which may be viewed as connected subgraphs of larger social network graphs). Examples of non-human objects that may exist in an expanded social network graph may include, but are not limited to, documents, topics, ontologies, word nets, and the like. In general, what distinguishes expanded social network graphs from graphs in general is that an expanded social network graph always comprises at least one social network graph as a subgraph, which one or more social network graphs are then expanded through the addition of objects having relationships to each other and ultimately to one or more of the people comprising the one or more social network graphs. That is, in an expanded social network graph, edges may represent relationships between individuals, relationships between an individual and an object of another type (than human) such as a document, topic, and the like, and relationships between objects other than people (for example, a document might have a directed edge or relationship of type “concerns” that leads to a topic). More examples of expanded social network graphs will be provided below as needed.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, an expanded social network database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded social network database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

Similarly, preferred embodiments of the invention are described in terms of a web-based implementation, including components such as web servers and web application servers. However, such components are merely exemplary of a means for providing services over a large-scale public data network such as the Internet, and other implementation choices could be made without departing from the scope of the invention. For instance, while embodiments described herein deliver their services using web services accessed via one or more webs servers that in turn interact with one or more applications hosted on application servers, other approaches such as peer-to-peer networking, direct client-server integration using the Internet as a communication means between clients and servers, or use of mobile applications interacting over a mobile data network with a one or more dedicated servers are all possible within the scope of the invention. Accordingly, all references to web services, web servers, application servers, and an Internet should be taken as exemplary rather than limiting, as the inventive concept is not tied to these particular implementation choices.

“Ontology”, as used herein, means a formal representation (generally in a formal data structure) of a set of knowledge and concepts pertaining to a particular domain (for example, to “financial management” or “medical diagnosis”), and of the relationships between a plurality of concepts pertaining to a domain. An “accepted ontology” is an ontology for a specific domain that is widely accepted by users, experts, or practitioners in that domain. For example, specialized ontologies exist and are widely available for specific domains, such as DublinCORE in the domain of library science and information retrieval, WordNet in the domain of language, and SIOC in the domain of online communities (“SIOC” stands for “Semantically-Interlinked Online Communities”). One common form or element of ontologies (whether accepted, proprietary, or ad hoc) is known as a “word net”, which is a graph-based representation of relationships among a wide variety of words within a given domain. For example, the words “conservation” and “momentum” are each likely to appear in ontologies covering the domains of “physics” and “environmentalism”, but they are likely to have very different meanings and their relationship in the two domains will be quite different. In physics, “conservation” and “momentum” will be generally located quite close to each other in a word net (distance referring to a minimum number of edges that must be traversed to move from one word to the other within a word net), because the concept “conservation of momentum” is a core physics concept. On the other hand, in environmentalism the two words are unlikely to be tightly related in any word net. “Conservation” is a core concept of environmentalism, along with other similar concepts such as “sustainability”, whereas “momentum” is likely to exist solely as a way to describe an overall rate of progress of some environmental or political movement toward some goal (as in “the momentum of the movement to action with respect to anthropomorphic global warming has decreased in the last two years”).

A “Bayesian network” or “Bayesian net” is a probabilistic graph-based model that represents a set of random variables and their conditional dependencies. For example, a Bayesian network could represent the probabilistic relationships between diseases and symptoms. Given symptoms, the network can be used to compute the probabilities of the presence of various diseases. Formally, Bayesian networks are graphs whose nodes represent random variables in the Bayesian sense (i.e., they may be for example observable quantities, unknown parameters, or hypotheses. Edges represent conditional dependencies; nodes that are not connected represent variables that are independent of each other. Bayesian nets can be used to determine a probability or likelihood of an outcome based on various prior inputs; for example, by calculating a probability of a particular term having a specific meaning, especially when such calculations are weighted by one or more numerical inputs related a specific user.

“Natural language processing” is a branch of computer science and linguistics concerned with interactions between computers (and other electronic computing or information processing machines and devices) and human beings using “natural language”, that is, using speech or written text composed to closely parallel the way humans interact with each other (that is, with natural vocabulary and phraseology, as opposed to rigid and terse menus or other computer-centric interaction styles). Natural language processing is a well-established field in computer science research and applications, and often makes extensive use of techniques such as statistical language modeling, pattern recognition, semantic parsing, and the like.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, or on a network interface card. In a specific embodiment, the techniques disclosed herein may be implemented in software such as an operating system or in an application running on an operating system.

Software/hardware hybrid implementation(s) of at least some of the embodiment(s) disclosed herein may be implemented on a programmable machine selectively activated or reconfigured by a computer program stored in memory. Such network devices may have multiple network interfaces that may be configured or designed to utilize different types of network communication protocols. A general architecture for some of these machines may appear from the descriptions disclosed herein. According to specific embodiments, at least some of the features and/or functionalities of the various embodiments disclosed herein may be implemented on one or more general-purpose network host machines such as an end-user computer system, computer, network server or server system, mobile computing device (e.g., personal digital assistant, mobile phone, smartphone, laptop, tablet computer, or the like), consumer electronic device, music player, or any other suitable electronic device, router, switch, or the like, or any combination thereof. In at least some embodiments, at least some of the features and/or functionalities of the various embodiments disclosed herein may be implemented in one or more virtualized computing environments (e.g., network computing clouds, or the like).

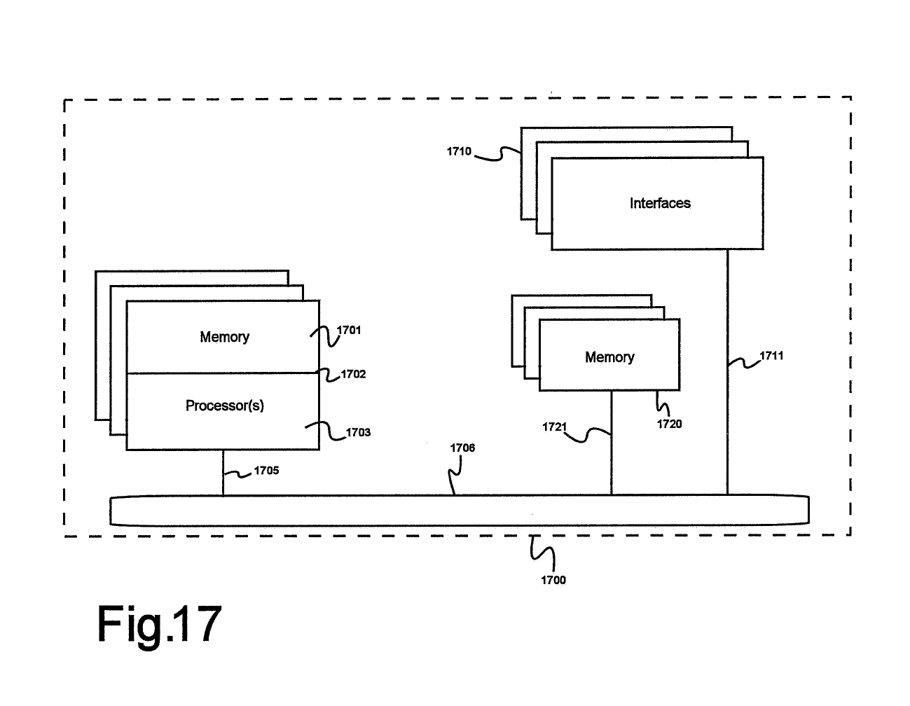

Referring now to FIG. 17, there is shown a block diagram depicting a computing device 1700 suitable for implementing at least a portion of the features and/or functionalities disclosed herein. Computing device 1700 may be, for example, an end-user computer system, network server or server system, mobile computing device (e.g., personal digital assistant, mobile phone, smartphone, laptop, tablet computer, or the like), consumer electronic device, music player, or any other suitable electronic device, or any combination or portion thereof. Computing device 1700 may be adapted to communicate with other computing devices, such as clients and/or servers, over a communications network such as the Internet, using known protocols for such communication, whether wireless or wired.

In one embodiment, computing device 1700 includes central processing unit (CPU) 1702, interfaces 1710, and a bus 1706 (such as a peripheral component interconnect (PCI) bus). When acting under the control of appropriate software or firmware, CPU 1702 may be responsible for implementing specific functions associated with the functions of a specifically configured computing device or machine. For example, in at least one embodiment, a user's tablet computing device might be configured or designed to function as an intelligent content management system utilizing CPU 1702, memory 1701, 1720, and interface(s) 1710. In at least one embodiment, CPU 1702 may be caused to perform one or more of the different types of functions and/or operations under the control of software modules/components, which for example, may include an operating system and any appropriate applications software, drivers, and the like.

CPU 1702 may include one or more processor(s) 1703 such as, for example, a processor from one of the Intel, ARM, Qualcomm, and AMD families of microprocessors. In some embodiments, processor(s) 1703 may include specially designed hardware (e.g., application-specific integrated circuits (ASICs), electrically erasable programmable read-only memories (EEPROMs), field-programmable gate arrays (FPGAs), and the like) for controlling operations of computing device 1700. In a specific embodiment, a memory 1701 (such as non-volatile random access memory (RAM) and/or read-only memory (ROM)) also forms part of CPU 1702. However, there are many different ways in which memory may be coupled to the system. Memory block 1701 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 1710 are provided as interface cards (sometimes referred to as “line cards”). Generally, they control the sending and receiving of data packets over a computing network and sometimes support other peripherals used with computing device 1700. Among the interfaces that may be provided are Ethernet interfaces, frame relay interfaces, cable interfaces, DSL interfaces, token ring interfaces, and the like. In addition, various types of interfaces may be provided such as, for example, universal serial bus (USB), Serial, Ethernet, Firewire™, PCI, parallel, radio frequency (RF), Bluetooth™, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 1710 may include ports appropriate for communication with appropriate media. In some cases, they may also include an independent processor and, in some in stances, volatile and/or non-volatile memory (e.g., RAM).

Although the system shown in FIG. 17 illustrates one specific architecture for a computing device 1700 for implementing the techniques of the invention(s) described herein, it is by no means the only device architecture on which at least a portion of the features and techniques described herein may be implemented. For example, architectures having one or any number of processors 1703 can be used, and such processors 1703 can be present in a single device or distributed among any number of devices. In one embodiment, a single processor 1703 handles communications as well as routing computations. In various embodiments, different types of features and/or functionalities may be implemented in a system according to the invention that includes a client device (such as a tablet computing device running client software) and server system(s) (such as a server system described in more detail below).

Regardless of network device configuration, the system of the present invention may employ one or more memories or memory modules (such as, for example, memory block 1720) configured to store data, program instructions for the general-purpose network operations and/or other information relating to the functionality of the embodiments described herein. The program instructions may control the operation of an operating system and/or one or more applications, for example. The memory or memories may also be configured to store data structures, domain and topic information, social network graph information, user actions information, and/or other specific non-program information described herein.

Because such information and program instructions may be employed to implement the systems/methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both machine code, such as produced by a compiler, and files containing higher level code that may be executed by the computer using an interpreter.

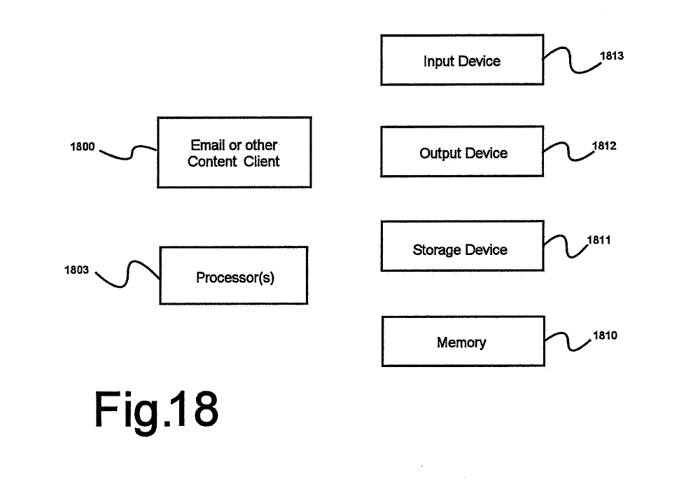

In some embodiments, systems used according to the present invention may be implemented on a standalone computing system. Referring now to FIG. 18, there is shown a block diagram depicting an architecture for implementing one or more embodiments or components thereof on a standalone computing system. Computing device 1700 includes processor(s) 1703 that run software for implementing for example an email or other document management client application 1800. Input device 1812 can be of any type suitable for receiving user input, including for example a keyboard, touchscreen, microphone (for example, for voice input), mouse, touchpad, trackball, five-way switch, joy stick, and/or any combination thereof. Output device 1811 can be a screen, speaker, printer, and/or any combination thereof. Memory 1810 can be random-access memory having a structure and architecture as are known in the art, for use by processor(s) 1703 for example to run software. Storage device 1811 can be any magnetic, optical, and/or electrical storage device for storage of data in digital form; examples include flash memory, magnetic hard drive, CD-ROM, and/or the like.

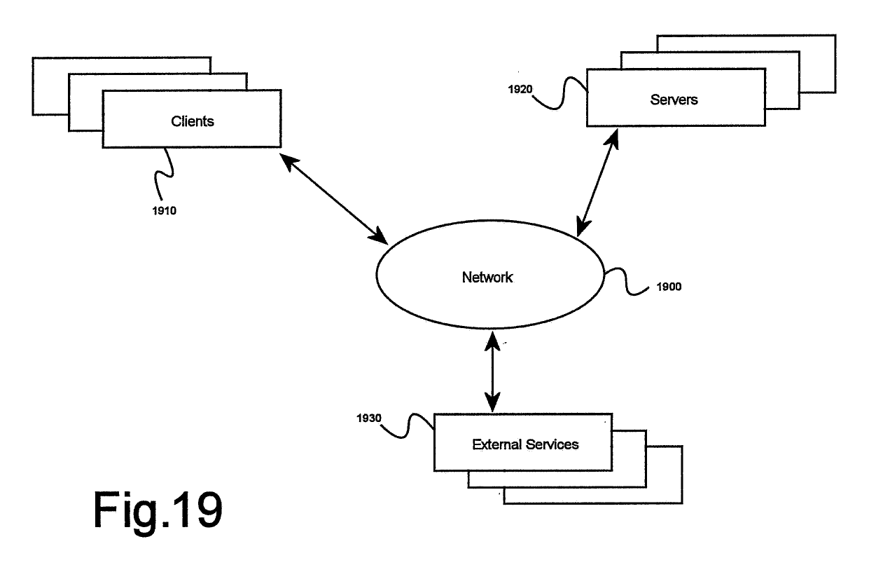

In some embodiments, the system of the present invention is implemented on a distributed computing network, such as one having any number of clients and/or servers. Referring now to FIG. 19, there is shown a block diagram depicting an architecture for implementing at least a portion of an intelligent content management system on a distributed computing network, according to at least one embodiment.

The arrangement shown in FIG. 19, any number of clients 1910 are provided; each client 1910 may run software for implementing client-side portions of the present invention. In addition, any number of servers 1920 can be provided for handling requests received from clients 1910. Clients 1910 and servers 1920 can communicate with one another via electronic network 1900, which may be in various embodiments any of the Internet, a wide area network, a mobile telephony network, a wireless network (such as WiFi, Wimax, and so forth), or a local area network (or indeed any network topology known in the art; the invention does not prefer any one network topology over any others). Network 1900 may be implemented using any known network protocols, including for example wired and/or wireless protocols.

In addition, in some embodiment, servers 1920 can call external services 1930 when needed to obtain additional information, to refer to additional data concerning a particular document or message, or to access for example curated data sources (for example, Wolfram Alpha™) in order to assist in building rich domain ontologies. Communications with external services 1930 can take place, for example, via network 1900. In various embodiments, external services 1930 include web-enabled services and/or functionality related to or installed on the hardware device itself. For example, in an embodiment where email client 1800 is implemented on a smartphone or other electronic device, client 1800 can obtain information stored in an email archive or a document store in the cloud or on an external service 1930 deployed on one or more of a particular enterprise's or user's premises.

In various embodiments, functionality for implementing the techniques of the present invention can be distributed among any number of client and/or server components. For example, various software modules can be implemented for performing various functions in connection with the pre sent invention, and such modules can be variously implemented to run on server and/or client components.

### Conceptual Architecture

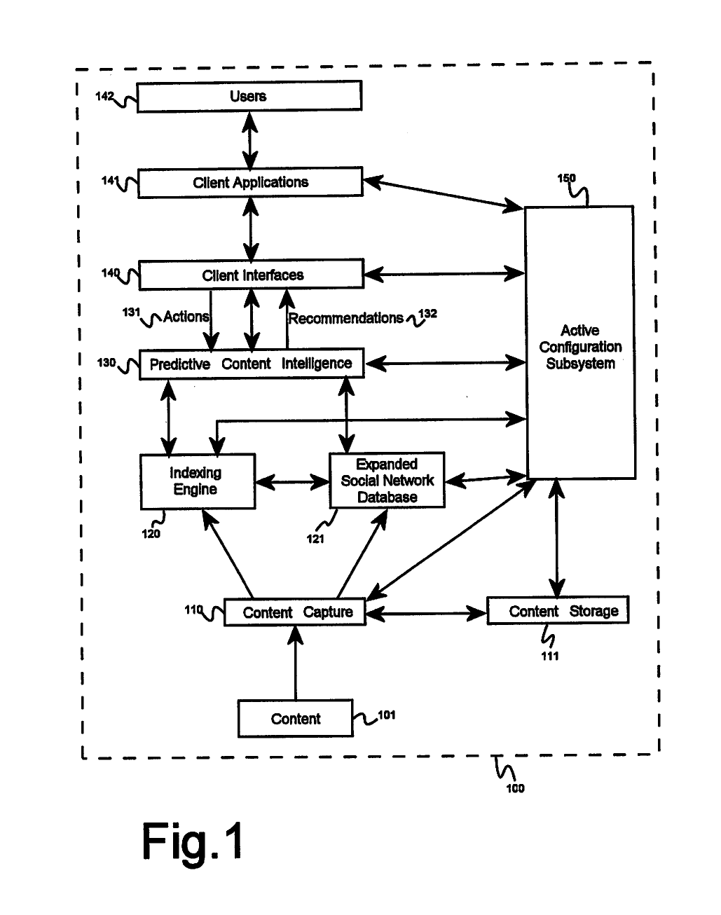

FIG. 1 is a block diagram illustrating a conceptual architecture of a system 100 for providing contextual recommendations within a document, document fragment, or other content object according to a preferred embodiment of the invention. As described in greater detail herein, different embodiments of contextual recommendation systems may be configured, designed, and/or operable to provide various different types of operations, functionalities, and/or features generally relating to content or document management technology (including for example, but not limited to, email management technology). Further, as described in greater detail herein, many of the various operations, functionalities, and/or features of contextual recommendation system(s) disclosed herein may provide may enable or provide different types of advantages and/or benefits to different entities interacting with content or document management system(s). The embodiment shown in FIG. 1 may be implemented using any of the hardware architectures described above, or using a different type of hardware architecture.

For example, according to different embodiments, at least some contextual recommendation system(s) may be configured, designed, and/or operable to provide various different types of operations, functionalities, and/or features, such as, for example, one or more of the following (or combinations thereof):
Automatically indexing incoming, outgoing, and archived emails, messages, and other documents to identify one or more topics addressed by each document, keywords or phrases present in each document, semantic structures present in each document, and persons having some relationship to each document (for example authors, reviewers, editors, users, senders, recipients, and the like).
Providing relevant recommendations of other people, topics, information sources, documents, or other content objects that may be useful to a user who is working with a first document, and making those recommendations available to the user within the first document. These recommendations may be modified dynamically as changes are made to the host document, or as the user navigates to various sections within the document (since different sections may concern various topics and therefore may benefit from different recommendations). Moreover, these recommendations may be made based at least partly on information about a specific user such as a user editing a document or other content item, so that recommendations are tailored to the specific user and therefore more likely to be relevant to him.
Enabling context-aware collaboration between a plurality of users by providing them with dynamic recommendations, within a document or content item regarding which collaboration is desired, of other people, topics, information sources, or content objects that may assist the collaborating users. These recommendations may be modified dynamically as changes are made to the host document or content object, or as the user navigates to various sections within the document or content object (since different sections may concern various topics and therefore may benefit from different recommendations).
Provide a context-rich “corporate memory” by automatically scanning structured and unstructured content repositories of a corporation (and potentially also of its affiliates, business partners, and content sources), indexing content objects obtained to determine their content topics and relevance to various ontological domains, and storing of resulting index information in an expanded social network graph database.

According to different embodiments, at least a portion of the various types of functions, operations, actions, and/or other features provided by content or document management client 1800 may be implemented at one or more client systems(s), at one or more server systems (s), and/or combinations thereof.

Additionally, various embodiments of system 100 described herein may include or provide a number of different advantages and/or benefits over currently existing email and document management technologies that provide recommendations to document viewers such as, for example, one or more of the following (or combinations thereof):
Rather than focusing solely on providing a list of contacts who may be of assistance to a viewer of a document such as an email, also providing recommendations regarding other content objects and topics that may help the viewer.
By treating all content objects as sources, various embodiments of system 100 may allow users of both more formal documents than email and of extremely informal (and often small and transitory) document types such as Twitter™, LinkedIn™, and Yammer™ posts to benefit from relevant and live (i.e., real time) recommendations, and may similarly provide links to, summaries of, or previews of such wide-ranging document types as well as of related emails.
In contrast to enterprise search engines known in the art, systems 100 according to the invention provide users with the ability to search a “corporate memory” for related documents or people based on rich ontological and/or social relationships between people, topics, content objects, and so forth. For example, documents with only a small, embedded section on a key topic might be identified and provided to a user, even though such a document would not normally be returned by enterprise search engines known in the art.

Referring now to FIG. 1, content 101 comprises objects upon which systems and methods of the present invention act, and users 142 interact with content objects and with systems and methods of the invention via one or more suitable client software applications 141, including for example (but not limited to) email clients such as Microsoft Outlook™, document-centric programs such as Microsoft Word™, Excel™, PowerPoint™, and the like, and messaging applications such as Twitter™, various instant messaging clients, and SMS clients. Generally, content objects 101 are captured in a content capture layer 110, which in some embodiments comprises a plurality of specialized content connectors, each typically (but not necessarily) specific to a particular content type. Content capture layer 110 may, in some embodiments, capture content objects from content storage layer 111, and in these and other embodiments it may also store some or all content objects 101 it captures in one or more subsystems comprising content storage layer 111. As will be described in more detail below, in some embodiments content objects which are not already archived and indexed in “native” systems (that is, systems that are designed specifically for a given object's type, such as email archiving systems or enterprise document management systems such as SharePoint™ from Microsoft), although in other embodiments all content objects captured are stored in one or more content storage layers 111. In some embodiments one or more content storage subsystems may be operated independently of an enterprise from which content objects stored therein are originated; for example, a cloud-based email archival solution may be used according to the invention to store and index emails from an enterprise.

Once documents, document fragments, or other content items are captured in content capture layer 110, they are then passed to indexing engine 120 for indexing and to expanded social network database 121 for addition to one or more expanded social network graphs. Processing by indexing engine 120 and expanded social network database 121 typically proceeds in parallel for each input content object, although in some embodiments one or the other system may first process a content object and then pass results to the other, according to the invention. Similarly, while in a preferred embodiment of the invention documents are passed automatically and substantially immediately upon capture from content capture subsystem 110 to indexing engine 120 and expanded social network database 121, in some embodiments it may be desirable to perform such transfers on a delayed basis. For example, in an embodiment documents are passed from content capture layer 110 to indexing engine 120 or to expanded social network database 121 only upon explicit user request, while in another embodiment content objects are passed “upstream” (that is, from content capture layer 110 to indexing engine 120 and expanded social network graph 121) in batch mode, for instance as when a group of documents is accumulated in content capture layer 110 until either a specified period of time has elapsed since the last push of content objects, or until a specific or minimum number of content objects has been accumulated), at which point all newly-captured content objects are passed upstream from content capture layer 110 to indexing engine 120 or expanded social network database 121, or both.

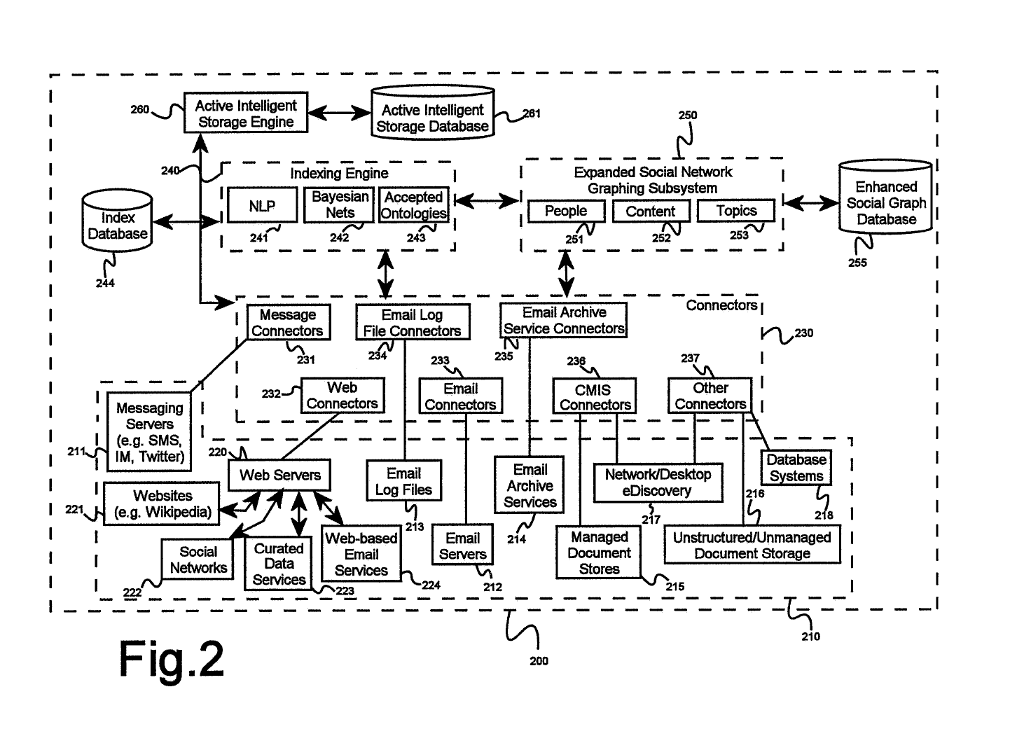

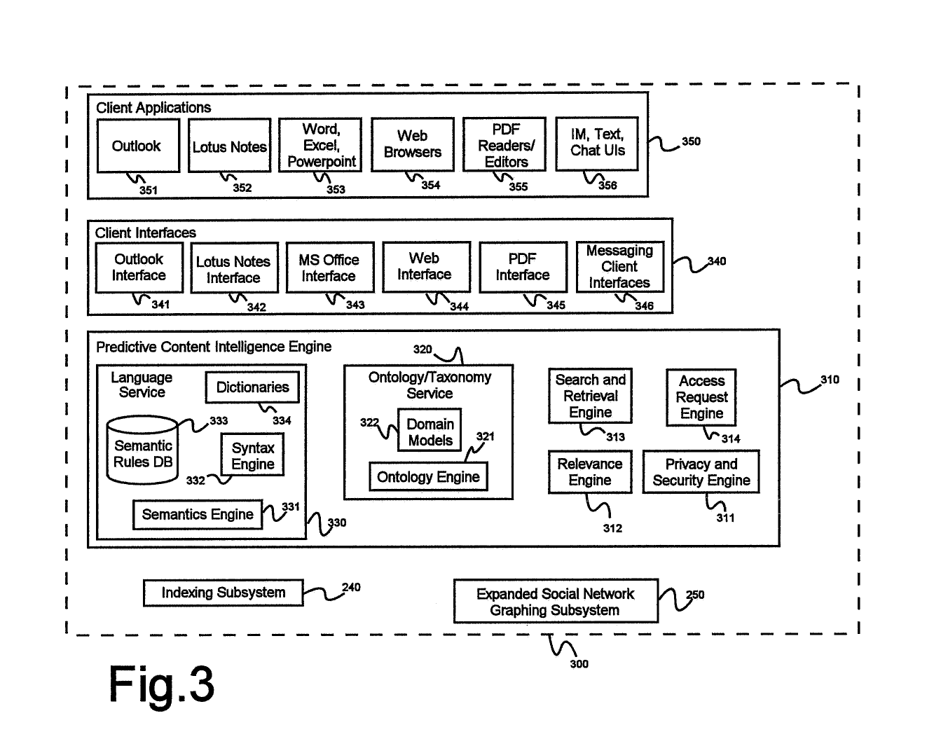

According to a preferred embodiment of the invention, content objects 101 passed to indexing engine 120 are analyzed by one or more indexing software routines or hardware circuits, as will be described in more detail with reference to FIG. 2, in order to add relevant data about content objects 101 to one or more content indexes maintained by indexing engine 120. Similarly, content objects 101 passed to expanded social network database 121 are analyzed by one or more software routines or hardware circuits, as will be described in more detail with reference to FIG. 2, in order to update one or more expanded social network graphs maintained by expanded social network graph database. Both indexing engine 120 and expanded social network database 121 feed results to, and receive feedback, predictive content intelligence layer 130. Predictive content intelligence layer 130 receives as input indexing information (from indexing engine 120) and either complete or partial expanded social network graphs or subgraphs (from expanded social network database 121), and use these inputs to determine one or more topics or contextual relationships within and between content objects 101 and users 142. Based on analyses performed by predictive content intelligence layer 130 (which will be described in more detail herein, at a minimum with reference to FIG. 3), one or more recommendations 132 may be generated and forwarded to one or more client interfaces 140 for further transmission to, or display within, one or more client applications 142. In this way, underlying semantic structure within content objects 101 may be used to determine one or more topics to which content objects 101 pertain, and relationships between topics, ontologies, people, and content objects 101 may be determined by expanded social network database 121, and these information may be used attributes to determine other content 101 or people 142 that may be helpful to a user 142 who is viewing one or more content objects 101, and such automatically-generated recommendations 132 may be passed to those users 142 for receipt via one or more client applications 141 in use by a particular user 142.

In preferred embodiments of the invention, information flow is not limited to one direction such as upward flow from content objects 101 to users 142, but may occur in much more complicated ways. For example, when a user 142 is presented with one or more automatically generated recommendations 132 while using client application 141, they may take one or more of several actions 131 based on those recommendations 132. Such actions 131 might include, but by no means are limited to, selecting a recommended content object 101 for review, contacting a recommended other user 142 to acquires assistance with a matter with regard to which a content object 101 is currently being viewed, marking of one or more recommendations 132 as “not relevant”, “offensive”, “highly relevant”, and the like, storing a set of recommended content objects 101 or people 142 for later review or later contact, and so forth. It will be appreciated that any number of natural actions 131 might be taken upon receiving a recommendation 142 while using a client application 142, and the invention is not limited to the particular examples described herein, which are intended merely to illustrate aspects of the invention. Furthermore, in some embodiments actions 131, or more particularly information about actions 131, are passed to predictive content intelligence layer 130 in order that current and future recommendations 132 might be adjusted based on the actions 131. For example, if a user 142 selects a subset of recommendation 132 presented to her in a client application 141 and specifies that they are not helpful and should be deleted, predictive content intelligence layer 130 will in some cases attempt to identify patterns that characterize undesirable recommendations 132, and to use these patterns to refine current and future recommendations 132 in order to reduce the relative frequency with which unhelpful recommendations 132 are provided to the user 142.

Finally, preferred embodiments of the invention further comprise an active configuration subsystem 150, which acts as a repository for configuration data required by one or more components of systems according to the invention. Beyond acting as a repository, in many embodiments active configuration subsystem 150 also acts plays a data validation role, ensuring that changes in configuration data that may be made in one or more components of a system 100 according to the invention obey any specified data integrity rules. In some embodiments, active configuration subsystem 150 also serves in a security role, acting to ensure that all actions that access, change, add, or delete configuration data are made by users 142, applications 141, or components that have been granted suitable permissions to make such changes. In other embodiments, security management, including aspects such as role-based access rules, are enforced by a separate security layer (not shown); it will be appreciates by one having ordinary skill in the art of large-scale software architectures that security functions may reside in one or more dedicated security modules, in an active configuration subsystem 150, or dispersed across some or all of the components of system 100, and that any such arrangement may be carried out without departing from the scope of the invention.

In general, then, FIG. 1 illustrates a high-level conceptual architecture in which content objects 101 act as the primary objects on which system 100 acts, by capturing them, parsing them and analyzing their syntactic, semantic, and/or ontological structure, building social network graphs around them based on sets of relationships between them and other objects of interest, and using the results of these parsing and analysis processes to generate recommendations 132 that can be passed to users 142 who are interacting with the content objects 101, and refining current and future recommendations and recommendation rules based on actions 131 taken by one or more users 142 in response to receiving such recommendations 132.

FIG. 2 is a block diagram illustrating an exemplary arrangement of components of a system 200 for providing contextual recommendations within a content object according to a preferred embodiment of the invention, and showing more detail regarding the high-level conceptual architecture shown in FIG. 1. According to the embodiment, content objects 101 are accessed via system 200 through the mediation of one or more content management applications or repositories 200. While any type of content management applications or repositories 210 may be used according to the invention, FIG. 2 illustrates several exemplary types of content management applications or repositories 210. Messaging servers 211 provide means for reading, receiving, sending, composing, and optionally archiving messages such as Twitter™ tweets, short message stack (SMS) messages, instant messages (IMs), chat messages, LinkedIn™, Facebook™, and other social network status update messages, and so forth. Websites 221 may provide access to a wide range of content types, including for example commercial web sites, Wikipedia articles, journalistic articles, blog posts, product and service reviews, and the like—all of which are of course content objects 101. Normally (but not exclusively), web sites 221 are accessed via one or more web servers 220, which may be operated by the owner or author of content objects 101, or by a service provider operating web sites 221 that is available to a plurality of such content owners or authors. Web servers 220 also act as intermediate service providers according to the art to provide users with access to social networks 222 and curated data services 223, although in some cases these networks and services may be accessed without involvement of web servers 220 (for example, if a dedicated mobile social networking application is provided that directly accesses a social network 222 without going through a web browser or a web server). Examples of curated data services 223 include, but are not limited to, services such as Wolfram Alpha™ which provides a large set of curated data sources and a web-enabled computation engine that, in combination, allow creation and dissemination of content objects 101 based at least in part on the curated data provided by the service.

One important class of content objects 101 envisioned by the inventors for enhancement by methods and systems according to the invention is email. Email is an extremely widespread form of communications, both for individuals and for businesses, and a wide range of products and services exist to effectively manage emails for various classes of users 142. In a growing number of cases, email is accessed by users 142 via web-based email services 224 such as HotMail™, Gmail™, Yahoo! Mail™, and the like; in other cases, email is delivered directly from enterprise-grade email servers 212 such as Microsoft Exchange™ or IBM LotusNotes™. Many email servers 212 generate email log files 213, which may comprise archival records of older emails, and there exist a range of dedicated email archiving services 214—some web-based, some cloud-based (these may also be web-based, but need not be), and some accessed directly by email servers 212. Examples of email archive services 214 include MessageLabs, Mimecase, Sonian, WebRoot, and the like. It will be appreciated by one having ordinary skill in the art of email management that there are many possible combinations of email servers 212, email archiving services 214, web-based email services 224, and email log files 213 that may collectively be used to provide a comprehensive suite of email solutions for any given customer or enterprise, and any or all of these may be used in any combination according to the invention as content sources.

Another important class of content management applications and repositories 200 is the class of managed content stores 215. Managed content stores 215 provide enhanced repository functions, including indexing, versioning, deduplication, security, and the like, and are commonly used in organizations to facilitate knowledge management, content management, and collaboration functions (which, it will be appreciated, often overlap each other considerably). A prominent example of a managed content store 215 is Microsoft SharePoint™. Systems such as email servers 212 and managed content stores 215 are typical of structured data storage systems, and in some cases they are also examples of managed data storage systems. Another very common type of structured data storage system is database systems 218, which may be relational databases such as Oracle™, Microsoft SQL Server™, and the like, or they may be non-relational (or “NoSQL”) database, such as Google's BigTable or even a flat file repository. In some cases, content objects 101 may be stored in databases, while in other instances document fragments or text-based data of value in building ontologies or semantic and topic models may be stored in databases 218.

Increasingly, prolific data and content creation rates in enterprises has led to significant challenges in meeting regulatory compliance and litigation-related discovery requirements, leading to the emergence of a relatively new class of content management applications or repositories 200, known as network and desktop eDiscovery applications and services. These services are similar in some respects to managed content stores 215 (for example, eDiscovery services 217 are similar to managed content stores 215 in that they typically include indexing, deduplication, and versioning, and provide a high level of content management capabilities), except they are more tightly focused on the needs of litigation and compliance managers, rather than being more general. Finally, unstructured and unmanaged content storage systems 216 generally comprise a variety of simple systems capable of storing large numbers of content objects and related data, but typically lacking indexing, deduplication, versioning, and robust security features. Examples of unstructured or unmanaged content storage systems including individual users' 142 “My Documents” folders on their computers and laptops (these are usually not synchronized, and often contain multiple copies of the same content objects, often with no version control whatsoever), attachments for emails and other messages (which often are stored with nothing more than a link to the containing message, and which are typically not indexed, not managed in any way, and which are often present in multiple copies, one per message that contains it). It is important to note that, in large enterprises, a great deal of data and a large number of content objects 101 typically only exist in one or more unmanaged or unstructured content storage systems 216, and these content objects 101 are commonly not easily located or searched by users 142.

For each class of content applications or repositories 200 present in an enterprise or other organization, there is provided according to the invention one or more connectors 230 that enables capture 110 of content objects 101. For example, a wide range of message connectors 231 and web connectors 232 are available in the art, allowing system 200 to access essentially any content objects or messages from messaging servers 211 or web servers 220 (and therefore also from web sites 221, social networks 222, curated data stores 223, and web-based email services 224). Similarly, email log file connectors 234 are adapted to retrieve and parse email log files 213, thereby extracting content objects 101, including emails and their attachments, that can be used by system 200. Email connectors 233 perform a similar function for email servers 212, generally using publicly available application programming interfaces (APIs) to connect to and communicate with email servers 212. Email archive service connectors 235 similarly provide systems 200 with access to email archive services 214 such as those mentioned above. Content management infrastructure services (CMIS) connectors are often used to directly access managed content storage systems 215 and network and desktop eDiscovery systems 217, which generally support CMIS; where such support is not available, managed content storage connectors may be implemented using open source, proprietary, or widely-available public APIs, as appropriate for a specific managed content storage system 215. It will be apparent to one having ordinary skill in the art that other connectors 237, of a wide variety of designs and interfaces known in the art, may be used to connect to any of the above content management applications and repositories 200, including for example unstructured or unmanaged content storage systems 216 and databases 218. In some embodiments, content connectors 230 may actually be software agents stored and operating on machines that host content objects, so that as any changes are made to stored content, or as any new content is added or edited, connectors 230 may immediately send notifications to indexing engine 240.

Once able to access and manipulate a large number of content objects 101 of different types and provenance, system 200 is able to extract valuable data from the content objects 101 themselves. An important type of data that can be extracted, according to the invention, is data pertaining to the meaning of a content 101 and potentially of component parts of a content object 101. Determining meaning of a text-based document has historically been a challenging problem toward which a number of approaches have been directed, many of which can be used singly or in combination, according to the invention, to derive meaning data (and similarly other important attributes such as the intent of a document's author, and so forth). As mentioned above with reference to FIG. 1, two main components of system 200 are responsible for analyzing content objects 101—indexing engine 240, and expanded social network graphing engine 250. Indexing engine 240 performs analysis on content objects 101 and uses results obtained to build and maintain index database 244, which contains one or more indexes that can be used to search a corpus of content objects 101. A primary purpose of content indexing is to make contents of a large number of content objects 101 rapidly and easily available, and to allow for identification of related content objects 101 (for example, content objects 101 that concern a particular topic).

In a preferred embodiment, indexing engine 240 comprises a natural language processing (NLP) module 241, one or more Bayesian nets 242, or one or more accepted ontologies 243. In some embodiments of the invention, one or more of these may be missing, and in other embodiments other text analytic techniques may be used. Considering NLP, Bayesian nets, and ontologies as an exemplary group of established technologies that can be used together for indexing content objects, one having ordinary skill in the art of text analytics will recognize that each brings particular strengths to bear on the common problem of parsing the linguistic content of a corpus of one or more content objects 101 in order to index them. For instance, NLP is well-suited for extracting semantic structure of sentences and paragraphs in order to determine which words are subjects, objects, active and passive verbs, adjectives, and so forth; NLP is also well-suited for determining structural and semantic characteristics of a segment of text, such as whether it is asking a question, making a statement, or performing some other function. Bayesian nets, on the other hand, are very useful for text disambiguation; for example the meaning of the word “lead” could mean several different things, which might or might not be easily distinguished by using NLP techniques, but which might easily be distinguished using a Bayesian net (in this case, given that words like “pencil” and “sharp” appear in a same sentence as “lead”, a Bayesian net would likely determine that the probability is greatest that the word “lead” means “pencil lead” as opposed to the chemical element or the verb associated with leadership). And ontologies, accepted or otherwise (these being primarily distinguished in that an accepted ontology is widely-known and accepted as being a good representation of a particular domain, whereas an ontology generally could be for instance a hand-crafted or automatically-generated model for a domain for which no accepted ontology exists, or for which one does but is found wanting) are generally very well-suited for classifying a particular text fragment as pertaining to one or a small number of topics. Topic classification is useful by itself, as it can help to interpret the meaning of a text fragment and can also help with disambiguation. For example, a phrase “take two and see me in the morning” might be well-understood from one syntactic and semantic point of view (for example, it might be an imperative statement advising someone to take two of something and see the speaker on the following morning; even so, depending on whether the phrase was spoken or written by Silvio Berlusconi or a country doctor, the meaning may vary significantly according to context), but what the recipient is supposed to take two of would generally be completely unknown. However, if the text was part of a passage which contained several words associated with a medical ontology (or if it was known a priori that the text was of a medical nature, and thus a medical ontology was used immediately), it would make sense to infer that “two” refers to two of some medicine; on the other hand, if the surrounding text or an initial classification suggested or required use of a sports training ontology (if one existed), then the phrase including “take two” would be interpreted to mean “run two laps and then see me about this in the morning”.

In a preferred embodiment of the invention, content indexing is performed both at an overall content object level and at a “content fragment” level. That is, larger content objects such as Word™ documents, presentations, and detailed articles online may be broken down into a series of fragments (for instance, based on headers or metadata provided with the document, or simply by analyzing the document paragraph by paragraph and then for optionally grouping paragraphs that have similar content into a larger fragment which can be indexed as a unit), and each fragment or group of fragments could be independently indexed by indexing engine 240.

By combining benefits of NLP, Bayesian nets, and ontologies, indexing engine 240 according to the invention can leverage strengths of each of them iteratively to more completely and efficiently determine meaning or intent, perform topic classifications, and perform other common indexing functions for a plurality of text fragments. As an example, consider an article from The Economist™, available online at http://www.economist.com/node/21531115; the article contains a number of differing themes about the software marketplace. For someone working in corporate finance, it contains key information on trends in business IT (information technology). A key theme discussed in the article is the use of consumer-focused products in industry, and how businesses are leveraging the large amount of research and development investment being poured into consumer products to benefit a wide range of industries through entrepreneurial startups and innovative technology companies in general. The article moves through several key subjects, including: group text communication, SMS, and telecommunications; consumer products being used in a business context; social networks and collaboration in business; use of smartphone applications in business; and savings available to businesses through the use of cloud computing services. The article also touches on other high-level domains such as “healthcare”. Given the rich variety of topics and contexts present in the article, and using tools currently available in the art, a search for “that article about use of social networks in business” would likely not find the article in question. While part of the reason has to do with the relationships between documents and people, which will be discussed below in reference to enhanced social network graphing engine 250 (because the antecedent basis of “that article” would be unknown to indexing engine, which has no concept of what articles a particular person may have recently viewed), another reason for the likely failure of conventional search or information retrieval approaches to satisfactorily handle the query in question is that the question requires a layered understanding of what a document is “about”. If a content object is considered to have only one or a small number of topics, a complex article such as the one linked to above would probably be classified broadly as relating to a small number of high-level categories such as “enterprise IT technology” and “consumer software” and so forth.

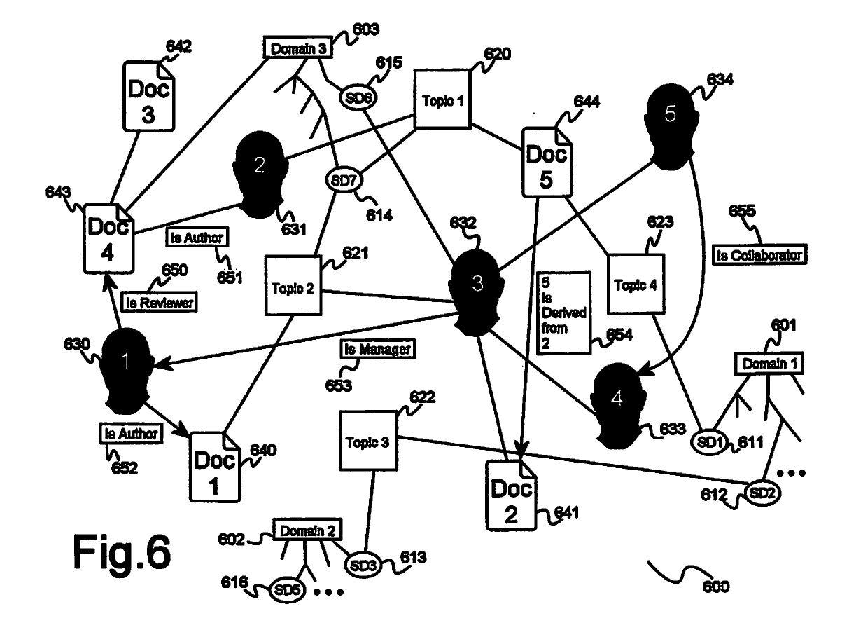

In a preferred embodiment of the invention, expanded social network graphing engine 250 maintains and uses expanded social network graph database 255. As discussed in the definitions section above, “expanded” in both of these terms refers to the novel concept of building and maintaining a network graph that not only captures the rich network of relationships between people 251, but also includes topics 253 and content objects 252 as nodes in a social network graph (more details about expanded social network graphs maintained in database 255 is provided with reference to FIG. 6). According to the embodiment, content objects 101 received from one or more content connectors 230 are either added to one or more expanded social network graphs (if they are not already present), or updated (if they are already present). Each content object 101 (in some embodiments also each content object fragment) is maintained as a node in expanded social network graph database 255. Relationships between a given content object 101 and other nodes are determined by results obtained from indexing engine 240, which will include references or relevance of a given content object 101 to people 251, other content objects 252, and topics 253. Thus if a content object 101 received by expanded social network graphing engine 250 is not present in expanded social network graph database 255, it will be added as a node, and edges will be added to represent any relationships determined by indexing engine 240. If a content object 101 does already exist in expanded social network graph database 255 when it arrives from content capture layer 230, then it may be updated by addition of edges representing newly identified relationships between the content object 101 and other content objects 252 or between the content object 101 and people 251 or topics 253.

In a preferred embodiment of the invention, content objects 101 that are not stored in one or more managed content storage systems (either operated by a customer or by a service provider) are passed to active intelligent storage engine 260, which manages such content objects, and active intelligent storage engine 260 causes the content objects 101 to be stored in active intelligent storage database 261. “Active intelligent storage” refers to a group of functions carried out by active intelligent storage engine 260 and active intelligent storage database 261 working cooperatively (in some embodiments, a single software module may carry out the functions of both components, rather than having such functions split among an engine—used for policy management—and a database—for storage management). For example, in an embodiment active intelligent storage engine 260 identifies when a piece of unstructured data (such as an email attachment or a file that is stored only on a local user hard drive without for example version control) is not resilient or unmanaged and therefore generates a copy of it, sending the copy to active intelligent storage database 261 for managed storage. “Unmanaged” means that a current repository is outside of administered control (e.g., a user's desktop or laptop), while “not resilient” means for example a situation such as an Exchange server with poor or no backup provisioning and no archive capabilities configured. In both cases (unmanaged and non-resilient documents), a copy of the entire content object is stored in addition to simply indexing data and semantics contained within the content object (which is what is done for managed content objects, such as those stored in a managed content storage system 215 such as SharePoint™)

As discussed above (see Definitions), index database 244, expanded social network graph database 255, and active intelligent storage database 261 may be combined in one database management system, each split into multiple physical database instances using techniques such as clustering or distributed database systems, or arranged in any other architectural arrangement known in the art for managing plural logical database systems. They are shown in FIG. 2 as separate databases because of their distinct logical functions, but one having ordinary skill in the art will understand that such a visualization is merely exemplary and does not exclude any particular database architecture from the scope of the invention.

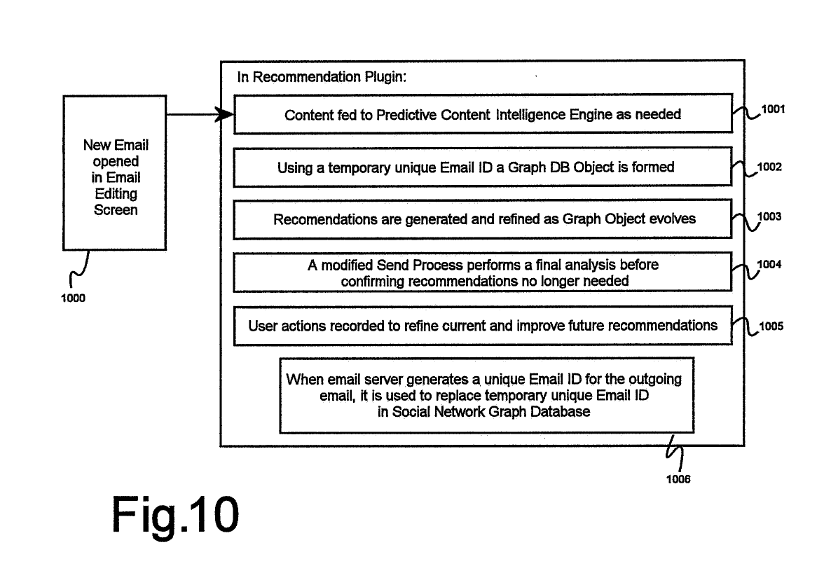

FIG. 3 is a block diagram illustrating an exemplary arrangement of predictive content intelligence 310, client interface layer 340, and client applications 350 components of a system 300, according to a preferred embodiment of the invention. FIG. 3 in effect “sits atop” FIG. 2, providing upper level functions responsible for tailoring user interface aspects based on results of content capture and analysis carried out in the components described with reference to FIG. 2. Specifically, indexing subsystem 240 and expanded social network graphing subsystem 250 represent the corresponding components illustrated in FIG. 2, and provide their outputs to (and receive feedback from) components illustrated and described here with reference to FIG. 3. As illustrated in and described with reference to FIG. 1, predictive content intelligence engine 310 draws input from indexing subsystem 240 and expanded social network graphing subsystem 250, specifically index data and expanded social network graph data. Additionally, as will be described in more detail below with reference to FIG. 10, predictive content intelligence engine 310 may also provide feedback to indexing subsystem 240 and expanded social network graphing subsystem 250.

Predictive content intelligence engine 310 comprises a number of components that provide various content analysis capabilities, which will be discussed in turn. Language services 330 comprise a set of software modules that perform linguistic analysis of content objects. Linguistic analysis, as is well understood in the art, can generally be broken down into two main inquiries: semantic analysis and syntactic analysis. Syntactic analysis, or analysis of syntax of a text fragment or document, focuses on word order and structural aspects of phrases and sentences to determine what roles particular words play in a text. For example, the verb “read” could be past or present tense, and in some cases it may be possible to determine which by analyzing the word's location and role within a clause, phrase, or sentence. Similarly, the word “lead” could be a verb or a noun, determining which role (or part of speech) it plays in a given text is a syntactic inquiry. Syntax analysis is conducted within language service 330 by syntax engine 332 in conjunction with one or more dictionaries 334 (dictionaries 334 here taken to mean databases containing words and their definitions and available grammatical roles); it will be appreciated that dictionaries are needed in order for syntax engine 332 to function, since it must at least know the possible roles of each given word, so that it can then apply known grammatical rules to a collection of words that make up a sentence in order to determine likely roles for each word. It will also be appreciated by one having ordinary skill in the art that dictionary 334 could be combined with syntax engine 332 in a single software application or a single dedicated processing node, and that there could also be a plurality of each arranged in any way desired among one or more physical devices; dictionary 334 and syntax engine 332 are shown separately to highlight their distinct logical roles. Semantics engine 331 analyzes a document's semantic content in order to determine likely meanings of various text elements that comprise the document. In preferred embodiments semantics engine 331 analyzes text elements ranging from sentences to paragraphs, larger document fragments such as sections, and indeed documents as a whole, which is particularly helpful since, as illustrated above, a single document may be “about” several distinct things, each of which may be the focus of one or more distinct text fragments (and of course some essentially atomic or indivisible text fragments may themselves be concerned with more than one subject). It will be appreciated by one having ordinary skill in the art that conducting semantic analysis at multiple levels of granularity helps automatically develop information that can be used to identify an overall topic for a document, as well as subsidiary topics including those that may be confined to one or a small number of document sections or fragments. Semantic rules database 333 is a database that stores and manages semantic rules that may be used by semantic engine 331. As will be appreciated, semantic rules may be organized by language, dialect, and high-level topics; for example, quite different semantic analysis rules would be used for a French short story as compared to an English physics research paper (and the differences would typically be more than simply the differences between French and English; short story prose is semantically quite different than research writing in the physical sciences. It will be understood by one having ordinary skill in the art that language service 330, by combining the use of syntax engine 332 and semantic engine 331, will generally be able to make definite statements about what each word in a text means, and about the general thrust of the text or even its subject and overall meaning, but what will usually be missing is any sense of the broader context and likely meaning that could be inferred from the text, since language service 330 is concerned with the structure and meaning of a language (and in some embodiments of many languages, each with its own set of dictionaries 334 and semantic rules 333), but is not concerned with the structure and content of domains of knowledge; that is the role of ontology.

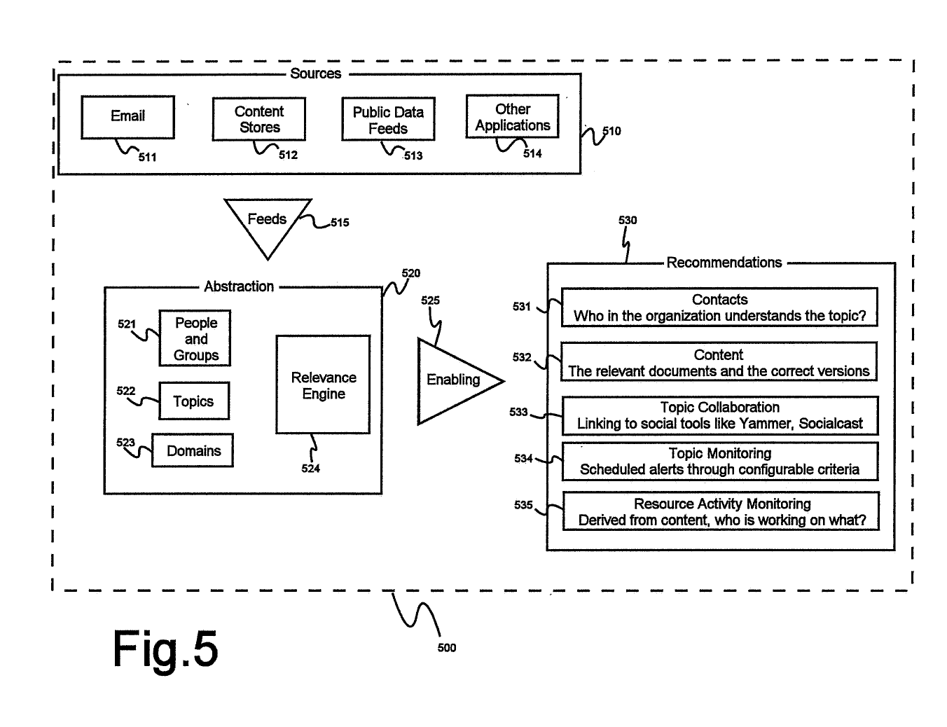

Accordingly, ontology and taxonomy service 320 provides a range of capabilities that supplement the work of language service 330 by bringing into the picture domain-specific knowledge. Ontology/taxonomy service 320 comprises an ontology engine 321 and a plurality of domain models 322. Domain models 322 may comprise both word nets and hierarchical domain ontologies (the first comprising a graph of relationships between a large number of words based on their usage within the domain of interest, and the second being an ordered representation of the sum of knowledge about a given domain). According to the invention, ontological data may be stored and processed separately by indexing subsystem 240 (which generally focuses on accepted ontologies and uses fairly static data to make indexing decisions concerning a particular text) and ontology engine 320 within predictive content intelligence engine 310 (ontology engine 320 focuses on an adaptive set of ontologies tailored to a particular organization or set of users 142, and are built generally starting with accepted ontologies and then from a corpus that is comprised of all content objects seen up to some point in time from a particular organization—each content object processed will tend to further refine and enhance relevant domain models 322 in ontology engine 320). But it should be understood that this arrangement is simply exemplary and not limiting; in some embodiments a single ontology engine 320 with a single set of domain models 322 may be used both for indexing and for predictive content intelligence. More details on specific processes used in predictive content intelligence engine 310 will be provided below with reference to FIGS. 5, 6, 9, 10, and 11 below.

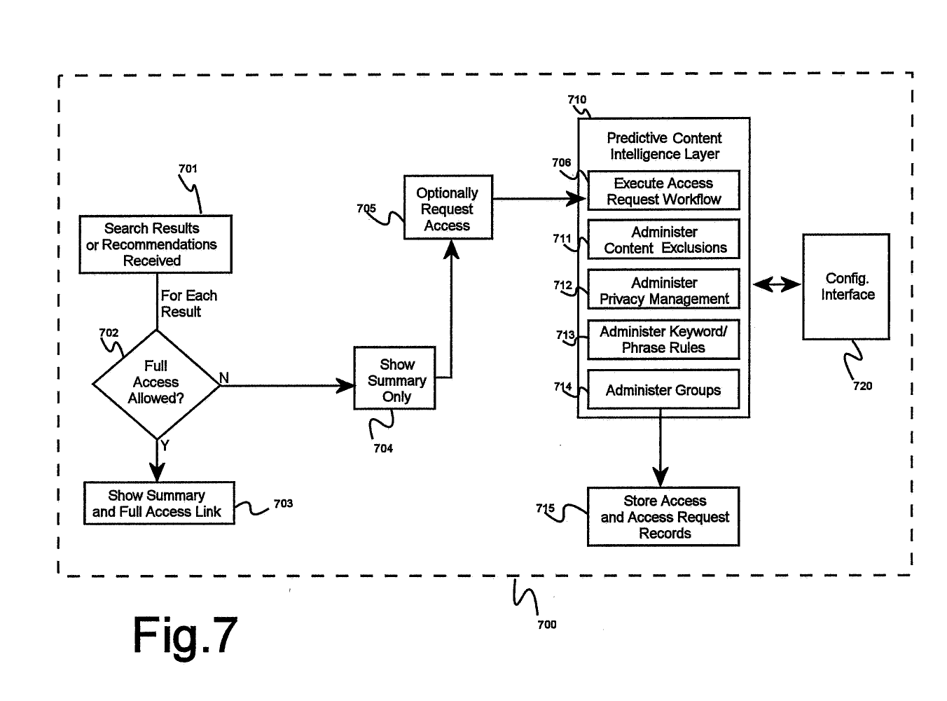

According to an embodiment, predictive content intelligence engine 310 further comprises a search and retrieval engine 313 to enable a user 142 to actively query system 100 for content objects 101 or other information that may be relevant to a particular content object 101 the user is processing. Similarly, predictive content intelligence engine 310 will, according to a preferred embodiment, comprise an access request engine 314 that allows a user to request a greater level of access to a particular content object or person than is initially provided by system 100. More details about an active security management and access control process used by the preferred embodiment is provided with reference to FIG. 7 below. Predictive content intelligence engine 310 also comprises, in some embodiments, a privacy and security engine 311 that stores, manages, and administers a set of rules pertaining to security and to the maintenance of privacy of users 142. In some embodiments, access request engine 314 and privacy and security engine 311 are combined into a single software module, as their roles are closely related.

Finally, in a preferred embodiment predictive content intelligence engine 310 comprises a relevance engine 312, whose function is to take into account one or more of expanded social network graphs, index elements, and results from language and ontological analysis, in order to select and prioritize a plurality of recommendations that may be provided to users 142 based on one or more content objects 101 being viewed, edited, created, or otherwise interacted with by the user 142. The role of relevance engine 312 will be described in more detail with reference to FIG. 5 below.

In a preferred embodiment of the invention, one or more client interfaces 340 provide programmatic access to predictive content intelligence engine 310 for a plurality of client applications 350, which client applications 350 are in turn interacted with by users 142, generally in the context of users' 142 interacting with one or more content objects 101. In general, users 142 may, while interacting with a content object 101 in a client application 350, receive one or more recommendations 132 within the particular client application 350 being used, the recommendations 132 being transmitted to client applications 350 by client interfaces 340. Similarly, actions 131 taken by users 142 in response to recommendations 132 may be passed from client applications 350, via client interfaces 340, to predictive content intelligence engine 310, where the actions 131 may be used to modify current or future recommendations 132 to the same or another user 142. While not an exhaustive list, representative client applications 350 may comprise Microsoft Outlook™ clients 351, IBM Lotus Notes™ clients 352, Microsoft Office™ clients 353 including for example Word™, Excel™, and PowerPoint™, web browsers 354 such as Microsoft Internet Explorer™, Mozilla Firefox™, or Apple Safari™ portable document format (PDF) readers and editors 355, and instant messaging (IM), chat, SMS, and other messaging clients 356, although of course any content-appropriate client application 350 may be used, according to the invention, if a suitable client interface 340 is available. Corresponding to these exemplary client applications 350, embodiments of the invention may comprise client interfaces 340 such as An Outlook™ interface 341, a Lotus Notes™ interface 342, one or more Microsoft Office™ interfaces 343, one or more web interfaces 344 such as web servers, one or more PDF interfaces 345, one or more messaging client interfaces 346, and of course any other interfaces 340 as may be required for other client applications 350.

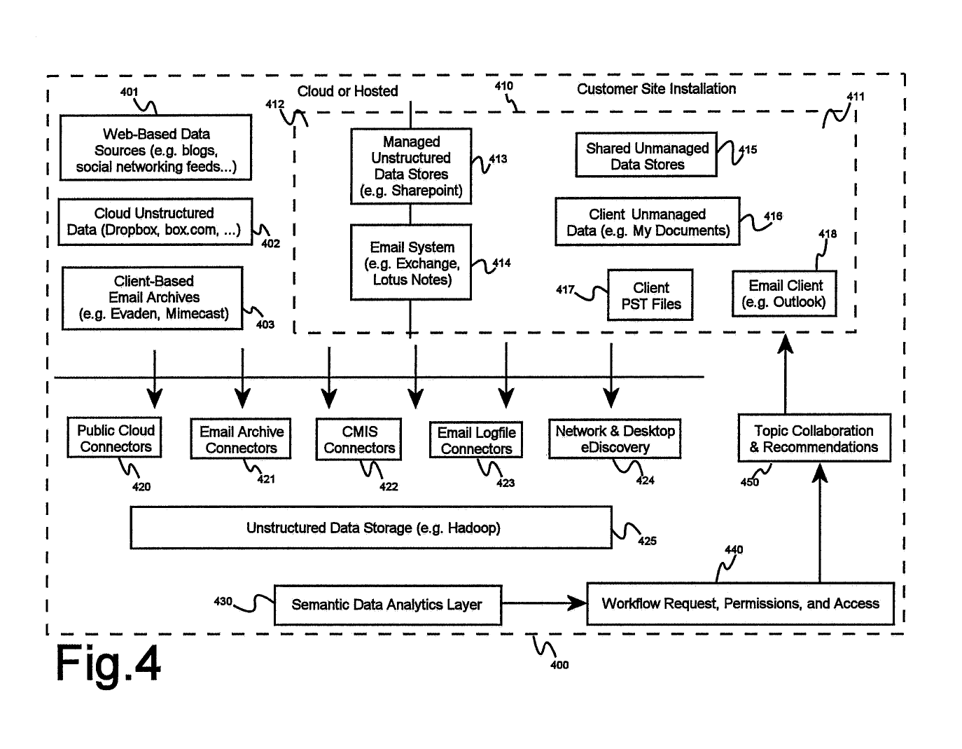

FIG. 4 is a block diagram illustrating a system landscape 400 showing an exemplary physical arrangement of components, according to an embodiment of the invention. The solid horizontal line in the middle of FIG. 4 generally defines a common interface point between components of system 100 according to the invention (below the horizontal line), and components used by users 142 or clients of system 100 (above the line). Similarly, some client components are operated directly by those clients 410, while others may be operated by third parties whose components are made accessible to clients 410 (such as, for example, the components in the upper left corner of FIG. 4). Similarly, components operated directly by clients 410 may be located either in a cloud or hosted facility 412, or on one or more premises 411 of client 410. Broadly, client components are comprised chiefly of content sources and user applications 350. While only email client 418 is shown as an example of a client application 350 in FIG. 4, it should be understood that any document- or message-based client application 350 may also be present either in clouds 410 or on client premises. Similarly, the various content sources illustrated in FIG. 4 are merely exemplary of the fact that client components can be located essentially anywhere, and any client content or message sources whatsoever may be used to provide input into system 100, according to the invention. Examples of third-party operated client content sources may include (but are not limited to) web-based data sources 401 such as blogs, social network feeds, web sites, curated data sources, and so forth, cloud unstructured data sources 402 such as box.com, DropBox, and the like, or client-based email archives 403 such as are provided by Evaden, Mimecast, and the like. Examples of client-operated content source components may include (but are not limited to) managed unstructured data stores 413 such as Microsoft SharePoint™, email systems 414 such as Microsoft Exchange™, Lotus Notes™, and the like, shared unmanaged data stores 415 such as public folders, client unmanaged data 416 (such as “My Documents” on users' 142 desktop and/or laptop computers), and client PST or email archive files 417. These various content sources, located variously in the cloud 412, on a client premise 411, or at third-party locations, interface with one or more appropriate content capture components 110, which may comprise (but are not limited to) public cloud connectors 420, email archive connectors 421, CMIS connectors 422, email logfile connectors 423, and network and desktop eDiscovery connectors 424. For content objects hat require intelligent active content storage, unstructured data storage 425 may be provided within system 100. As content objects are passed into system 100 and optionally stored there, they are then analyzed in semantic data analysis layer 430 (comprised normally of at least indexing subsystem 240 and expanded social network graphing layer 250). Results of content analysis may be passed to and used by software modules that manage workflow requests, permissions, and document access 440, and then suitably modified topic collaborations and recommendations 450 may be passed back to client users 142, generally via a client application such as an email client 415. Of course, it should be understood that the dispersed physical and organizational arrangement of components illustrated in FIG. 4 is just one of many possible such arrangements, and is provided to serve as an example of the fact that components of system 100 may be arranged in widely-varying physical and organizational architectures. That is, FIG. 4 should be considered an exemplary system landscape showing a typical arrangement according to a preferred embodiment of the invention.

FIG. 5 is a block diagram showing relationships among various logical entities, according to an embodiment of the invention. According to the embodiment, a variety of content sources 510 may include email 511, content stores of various kinds 512, public data feeds 513, and other applications 514 (many content sources have been described already above); these sources act to feed 515 documents, messages, fragments of either, or other content objects, to an abstraction layer 520. Abstraction layer 520, which is a logical element corresponding roughly to indexing layer 240 and expanded social network graphing engine 250 and predictive content intelligence engine 310, serves to extract abstract information pertaining to one or more content objects, for example a document's author or authors, its intended recipients, its meaning, its organization, and its relevance to various topics. More specifically, abstraction layer 520 abstracts relevant relationships between a content object and one or more people and groups 521, topics 522, and (ontological) domains 523. More details on these relationships is provided below with reference to FIG. 6. Based on abstractions carried out in abstraction layer 520, a plurality of people and groups 521, topics 522, and domains 523 may be passed to relevance engine 524 for ranking based on their likely relevance to a user 142 viewing a content object 101 from which the abstraction was made. That is, abstraction layer 520 might identify various relationships involving dozens of people, groups, topics, and domains based on a single complex content object. Some of the people, groups, topics, and domains might be useful to a user 142 viewing or editing the content object 101 being abstracted; relevance engine 524 uses various techniques, for example techniques based on use of an expanded social network graph, to estimate the relevance of each of the people, groups, topics, and domains, in order to provide information to user 142 in a useful way (for example, rather than overwhelming a user with a comprehensive list of possibly relevant items, relevance engine 524 may provide only the five most relevant items to user 142, allowing user 142 to request more items as desired). The abstractions and correlations made in abstraction layer 520 enable 525 a variety of user recommendations 530 to users 142. Recommendations 530 may take several forms. Contacts 531 may be recommended to a user 142, for example when a particular person (contact 531) is recommended as an expert on the subject matter of a particular content object (expertise may be inferred by abstraction engine 520 from a variety of relationships between the contact 531 in question and the content object 101 within which or with regard to which the recommendation is made, for example if the contact 531 is the author of the content object 101, has authored other content objects 101 on the same or similar topics 522, or is an expert in a relevant domain 523). Typically, contacts 531 are recommended in response to the question “Who in the organization understands this topic?” Related content 532 may be recommended as well, including optionally specific versions of related content 532. Topic collaborations 533 may be recommended as well, for example in one embodiment through integration or linking to one or more enterprise social network tools such as Yammer, Jive Software, or Socialcast. In another embodiment, rather than recommendations passing from abstraction layer 520 to a user 142, alerts are provided in response to topic monitoring requests 534. That is, a user 142 may request to be notified whenever a content object corresponding to a specific topic is added to or modified within one or more content stores (for example, when emails are received pertaining to the topic in question). Then, when such content objects are detected by abstraction layer 520, an alert is sent to the requesting user 142 advising her of the new content. In another embodiment, similar to topic monitoring, users 142 may request to monitor activity 535 of other people or groups 521, receiving alerts or periodic reports on those activities. For example, a user 142 may specifically ask to be notified whenever a specific other person 521 is working on documents, messages, or other work items pertaining to one or more specific topics 522. Overall, content processing system 500 illustrated in FIG. 5 continuously analyzes a large corpus of content objects of various types, abstracts meaning and context from them, and generates various types of recommendations that it passes to users who interact with one or more of the content objects.

FIG. 6 is a diagram showing an expanded social network graph 600, according to an embodiment of the invention. “Normal” social network graphs generally have as nodes people only, and edges represent relationships between people. By contrast, according to various preferred embodiments of the invention expanded social network graph 600, nodes may represent people 630-634, content objects 640-644, topics 620-623, and ontological domains 601-603 (and optionally subdomains 611-615). By dynamically creating a graph that encompasses not only social relationships between people 630-634 but also a much broader range of relationships between objects (nodes) of various types, the richness and value of expanded social network graph 600 is greatly improved. Considering several relationships as examples, relationship 650 denotes that person 1 630 is (or was) a reviewer of document 4 643; relationship 651 denotes that person 2 631 is an author of document 4 643; relationship 652 denotes that person 1 630 is an author of document 1 640; relationship 653 denotes that person 3 632 is a manager of person 1 630; relationship 654 denotes that document 5 644 is derived at least from document 2 641; and relationship 655 denotes that person 5 634 is a collaborator of person 4 633 (this last is a good example of a relationship that would typically be bidirectional, whereas the other examples would typically be directed relationships proceeding only in one direction). It can be seen that a wide range of important relationships can be captured in this way, particularly when graph 600 is quite large (for example, in a large organization, it might span thousands of people, hundreds of topics across dozens of domains, and millions of content objects—such scale would have been impractical only a few years ago, but with modern data architectures a graph of such size can easily be managed and used, according to the invention).

FIG. 7 is a process flow diagram illustrating a process 700 for active security management, according to an embodiment of the invention. According to the embodiment, in a first step 701, a user 42 receives one or more recommendations or search results 132 from predictive content intelligence layer 130. For each result (taken to include any of recommendations, search results, alerts, etc.), in step 702, a check is made to determine if full access to any objects (people, topics, content objects, domains) included in the result is authorized for the user 142 viewing the result. In general, in preferred embodiments, each object may optionally be configured with more or less specific rules regarding who may have full access to them; in some embodiments there may be several levels of access that may be granted. Many objects may be given default rules that will apply when no specific rules for a given user 142 (or for any group of which the user 142 is a member), and rules may be established that apply to a range or group of objects or to a group or range of users 142. It will be appreciated that, according to various embodiments, there may be more than one access rule that may be applicable to a given object—person pairing (that is, that apply to the question of whether a particular person is to be granted access, and at what level, to a particular object that is part of a result); when this is the case, in most embodiments the most specific rule will be applied (for example, if there is a rule specifying access rights of a specific user 142 to a specific object, then this rule would be selected over any rules that apply to groups of objects or users 142), although any other rule selection approaches may be used according to the invention. According to the invention, “access” may mean different things, depending on the nature of the object to which an access rule is applied. For example, if the object is a person who happens to be a member of an organization's Board of Directors, access rules might allow only certain individuals to be able to view contact information for the object/person; other rules for access to people might include whether or not to provide, in a client application 141, a one-click access means (such as a click-to-dial or an active email link), or whether and how much background information about the object/person being accessed to display to the user 142 to whom access is being granted. If the object is a content object 101, access rules might specify, for example, whether only header information that informs a viewing user 142 that a specific document exists (and possibly where or from whom it can be obtained), or whether the document itself can be viewed or even edited by the user. It will be appreciated by one having ordinary skill in the art of role-based and user-based security mechanisms that a wide range of access rules for various types of object access for various users 142 may be employed, any combination of which may be used without departing from the scope of the invention. If full access is allowed in step 702, then in step 703 a summary of the document or other high-level descriptive information pertaining to the object to be accessed, as well as a link or other means for gaining full access to the content object, is displayed in a client application 141. If full access is not allowed in step 702, then in step 704 a summary view of the referenced object is provided to user 142 in client application 141. At this point, a user may opt in step 705 to request full access to the object in question. For example, taking the Board Member example above, if user 142 considers it important that she be allowed to speak with the individual Board Member, she can request access to the Board Member (or at least to the Board Member's contact information) in step 705, typically via client application 141, although other means may be used to make such a request. Requests for access are passed to predictive content intelligence layer 710, where they are typically handled by access request engine 314, usually in conjunction with privacy and security engine 311 (as mentioned before, these two logical components may be combined in one software module in some embodiments). Access request engine 314 evaluates each request in step 706, generally by carrying out an access request workflow that involves at least checking one or more access rules to see if the requesting user 142 can, on request, be granted access. In many cases, however, it will be necessary in step 706 for access request engine 314 to send a “pending” response to user 142, and then to contact one or more persons who either are designated as owners of the object to which access is being requested, or who have been granted power to grant or deny access to the object independently. In a preferred embodiment, such persons are sent an email notification that an access request has been submitted and required evaluation. Typically, each such access management email will contain a link that allows the receiving person to connect directly via a web browser or other suitable client application 141 to access request engine 314 to evaluate and either grant the request, deny the request, or respond to the request for example by in turn requesting additional information to be used in making a final decision on the request.

Other steps may be taken as part of an overall active security process, according to the invention, although these other steps need not all be taken and they need not be taken in any particular order. Most of these steps are, but need not necessarily be, carried out via a web browser client application 141, although in some embodiments one or more specialized applications 141 may be available to users 142 as well. In step 711, authorized users 142 may interact with privacy and security engine 311 to administer various content exclusion rules (for example, rules like the one mentioned above that limits access to the contact information of an organization's Board members). Content exclusions are typically established either for classes of content, groups of content objects, or specific content objects (these latter are often restricted by the content objects' owners or authors when the content objects are added to or created within system 100). In step 712, authorized users 142, typically security administrators, interact with privacy and security engine 311 to administer overall privacy rules and settings, and in step 713 they may similarly administer keyword or key phrase rules. Keyword or key phrase rules allow for creation of, for example, an exclusion list based on the presence (or absence) of one or more keywords or key phrases in a content object. For example documents and emails that refer to ‘salary review’ or other personal information within a company could be subject to a keyword/phrase rule that only allows a small number of designated managers to view their content; others might be able to see their subject lines or titles and other header-type information such as addressees and mailing date for emails, although even these might be limited by being viewable to only specific people or groups of people. As another example, team groupings could be created based on keywords so that certain designated people would automatically receive notification of and access to any content object that contains a specific keyword such as “project Babylon”, or alternatively content objects with specific keywords could automatically be added to a group collaborative workspace where each member of the group would see it whenever they entered the collaborative space, and where team members could openly share data and comments pertaining to the content object (either in the content object itself or in a designated area within the collaboration area). In step 714, authorized users 142 may interact with privacy and security engine 311 (or indeed with any other administration or configuration interface to system 100) to administer user groups, including in some embodiments administering organizational structure data (who reports to whom, who is on what team, who is located at which site or location, and so forth). When changes are made in steps 711-714, they are generally stored, as with other configuration data, in configuration database 150, via configuration interface 720. In some cases, steps 711-714 may be carried out directly in configuration interface 720. Finally, in step 715, a record of all accesses to content objects 101 and other objects, and of all access requests made for example in step 705, are stored either in configuration database 150 or in a local data store, such as an audit or log file, associated with, accessible to, or contained in privacy and security engine 311.

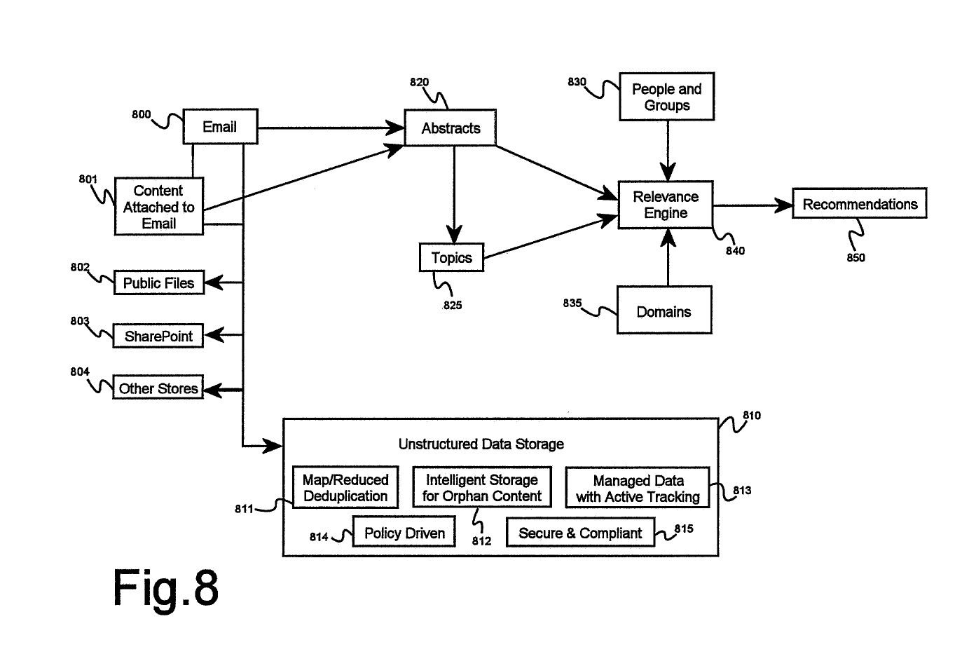

FIG. 8 is an illustration of an exemplary arrangement of information flows, according to an embodiment of the invention. For purposes of illustration, all flows will be shown as related to an email 800, although equivalent information flows are contemplated for any and all content object types. Email 800 is either created or received in an email client application 351, sometimes with other content objects 801 attached to the email (they may be attached when an email arrives, or may be added to email 800 during editing of email 800 or of a reply to email 800 (the reply is of course another email 800 itself, and analogous information flows may occur for it as well as for the original email 800 to which reply was made). Emails 800 and attached content objects 801 may be stored in a client's information systems in one or more of public files 802, managed data stores such as SharePoint 803, or other stores 804 (as described above, for example with reference to FIG. 2). In some embodiments, “orphaned” content objects may be stored in unstructured data storage 810, which is in a preferred embodiment maintained by an operator of system 100 for the purpose of providing active intelligent content storage features. Unstructured data storage 810 will, in most embodiments, be implemented in a highly scalable fashion, for example through use of a distributed data storage system such as Hadoop. Unstructured data storage 810 may, in some embodiments, provide one or more value-added features to clients, including but not limited to map/reduced deduplication 811 to efficiently and scalably manage data deduplication, intelligent storage for orphan content 812 (orphan content refers to content items, such as email attachments 801, that are not provided with managed storage facilities by a client's infrastructure), and managed data services with active tracking 813 (“active tracking” refers for example to providing continuously updated and optimized indexing, version control, distributed storage, and local caching of content items, so that every content element is available quickly, with full audit capability and known provenance, to authorized users anywhere in an organization). In most embodiments, unstructured data storage 810 is policy-driven 814 and is secure and facilitates regulatory compliance 815, thus making unstructured data storage 810 a natural and full-featured extension of managed data stores maintained within an enterprise. In addition to managed storage of content objects such as email 800 and its attachments 801, information is pulled from email 800 and its attachments 801 (by abstraction layer 520 or its equivalents) into one or more abstracts 820, which in turn are used to assign one or more topics 825 to email 800, its attachments 801, or to fragments of either (recall that “content analysis” methods discussed herein can be applied either to whole content objects, fragments of content objects, or indeed entire classes of content objects). One or more abstracts 820 and topics 825 may then be passed to relevance engine 840, which also receives information pertaining to people 830 and domains 835. Relevance engine 840 can then generate recommendations 850, based on combinations of content object abstracts, topics, domains, and people and groups of people. This conceptual diagram of information flows (that is, FIG. 8) makes clear that system 100 performs dual functions of maintaining a large-scale content object storage capability (some of which is operated directly by system 100, and some of which is already present on the premises of, and operated by, clients of system 100) and generating appropriate recommendations 850 that can be made available to users 142 in real time as they interact with content objects such as email 800 and its attachments 801.

It should be noted that relevance engine 840 may use many different techniques to tailor recommendations to a particular content user, based on potentially very specific and granular attributes of that user. For example, in a preferred embodiment a series of weighting factors and Bayesian techniques are used to determine which topics are most relevant to a user's current work. The weighting factors are configurable, and may comprise, for example, one or more of the user's work experience extracted from LinkedIn™ or other professional social networking sites, recent work performed or recent content interactions of the user, or a weighted topic mixture of previous communications from the user to others (particularly in email use cases, where previous communications between the two users—sender and recipient—can be mined for frequent topics). It will be appreciated by one having ordinary skill in the art that these are merely exemplary, and any number of factors may be taken into account that may reflect, to a greater or lesser degree, a relative likelihood of each of a plurality of potential topic's being relevant to the user at a specific moment, or at a specific location within a document, document fragment, or other content object.

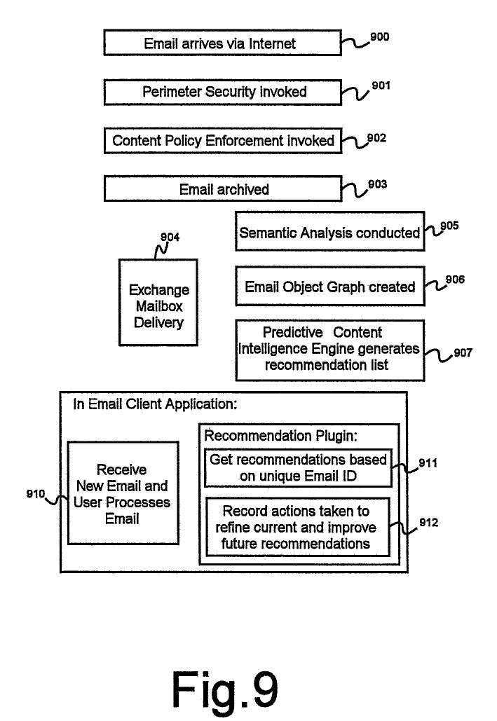

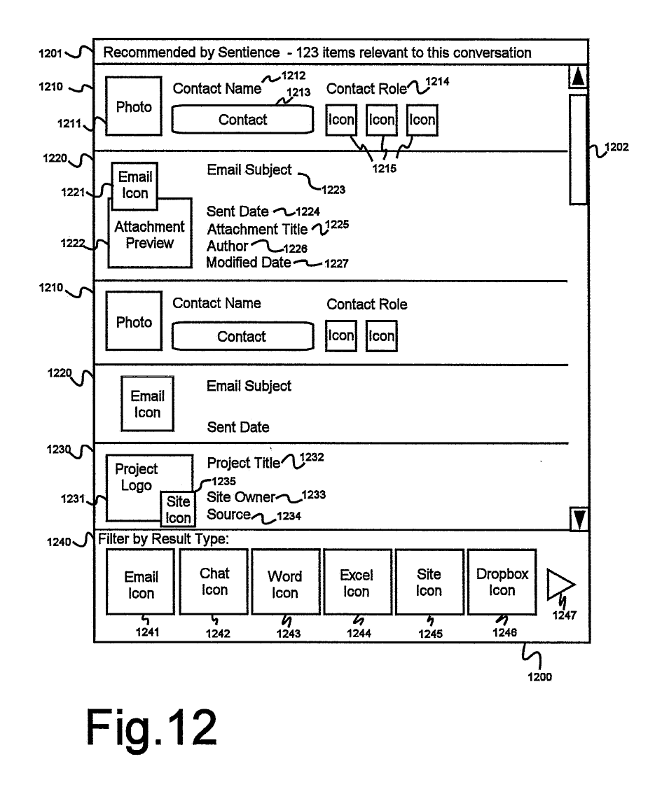

To make this process clear, FIG. 9 provides a process flow diagram illustrating an exemplary process for handling inbound email 800, according to a preferred embodiment of the invention. In a first step 900 an inbound email 800 arrives at email server 221 via the Internet or another network. In step 801, perimeter security systems (many varieties of which are well known in the art, and any of which may be used according to the invention) are invoked to inspect and/or otherwise validate (or not) the email before allowing it to pass (or not) further into the process. In step 702, one or more content policy enforcement rules could be invoked (again, using techniques and tools that are well known in the art, any of which may be used according to the invention). An example might be that any email containing suspected indecent content would be flagged and either deleted or diverted into a special folder where authorized personnel might screen it before allowing it to proceed further. Then, in step 903 the email may optionally be archived, as is often required for regulatory or litigation hold compliance. Once these initial steps are completed (if required), step 904 and steps 905-907 proceed in parallel. In step 904, the email is delivered to one or more recipient email inboxes based on the email's addressee list. In step 905, semantic analysis or, more broadly, intelligent content object analysis, is conducted as described above with reference to FIG. 3 and FIG. 5. Then, in step 906, an email object graph is created based on the results of analyses conducted in step 905. This is an important step, as without performing this step it would be difficult to know where in expanded social network graph 600 to place a node for a newly received email. When an email is analyzed, many relationships similar to those shown in FIG. 6 are usually inferable; for example, at least sender and recipient identities will generally be known and can be used to associate the email with at least two people (although rarely it might be true that a person sends an email only to himself, and therefore only one person would be known to be associated with the email directly, at least at first), and in many cases the content of email 800 will allow predictive content intelligence engine 310 to determine one or more topics 522 with respect to which email 800 is relevant. Based on some number of initial relationships that are inferred, an initial email object graph can be created to capture those relationships (in essence what is involved is a graph similar to that shown in FIG. 6, where one content object node represents email 800, others would represent any attachments or linked-to content objects (if appropriate), topics 522 would be topics determined by predictive content intelligence engine 310, people 521 would be at least those from whom and to whom the email 800 is sent (and potentially also people referred to in email 800), and domains 523 would by any domains identified by predictive content intelligence engine 310. In some embodiments, an initial email object graph created in step 906 may have a depth greater than one (which is what it would have if it simply had email 800 as a central node and each related object connected only to email 800). For example, if a person 521 such an addressee of email 800 was already present as a node in expanded social network graph 600, existing edges (links) directly to or from that person to other objects could be imported into the email object graph either on its creation or at any time thereafter. If only immediate links to or from person 521 in question are added, then with respect to these links the email object graph would be of depth 2 (1 for the link from email 800 to person 521, and then 1 more for the set of links directly to or from that person 521). It will be apparent to one having ordinary skill in the art that initial depth of email object graph can be as large as desired, limited either by available links (for example if there exists only one layer of links to or from each object to which email 800 is connected, then the maximum possible depth would be 2) or optionally by configured limits intended to limit the size of and computational demands imposed by the email object graph. With an email object graph thus created in step 906, in step 907 predictive content intelligence engine 310 generates a list of recommendations (usually one or more, but in some cases the list may return from step 907 as an empty list). Then, in email client application 351, each user 142 who is an intended recipient of email 800 will receive the new email 800 in his or her email inbox and may, at some point, choose to open and process email 800. When email 800 is opened, and usually (but not necessarily) within a well-defined email recommendation plugin (usually displayed as a frame, a popup window, or a dedicated tab within email client application 351), in step 911 the processing user 142 receives recommendations based on email 800′s unique email ID (unique email IDs are typically generated automatically by email server 221 or equivalent when email 800 is first submitted to it in step 904). In preferred embodiments of the invention, recommendations are tagged by unique email or other document identifiers, so that when a document is opened or otherwise processed (analogously to what happens in step 910), any recommendations that exist with the unique identifier corresponding to that document may be displayed in the document in a suitable recommendations plugin or interface region; where more recommendations are available than are typically displayable at one time, only a limited number of most highly relevant recommendations are initially displayed, and some form of interface element is introduced to allow a user to cause more recommendations to be displayed. When a user 142 is shown one or more recommendations in email client application 351, typically in a recommendation plugin or equivalent, the user 142 is usually also provided with at least one (and usually more) optional actions to take, such as “get next set of recommendations”, “mark as favorite”, “mark as not helpful/inappropriate/improper etc.”, “copy recommendation link”, “open recommended document”, “email recommended contact”, and so forth (examples of recommendation plugin views will be discussed in more detail below, with reference to FIGS. 12-17). In step 907, actions 131 taken by user 142 are recorded (typically directly by a recommendation plugin element in email client application 351 or its equivalent in other content management applications 350), and sent to predictive content intelligence engine 130 (see FIG. 1). Feedback regarding user actions in response to recommendations may be used, in various embodiments, to refine current recommendations (for instance, by reordering a recommendation list or by promoting, demoting, deleting, or adding recommendations). Action feedback may also be used advantageously, in various embodiments of the invention, to implement adaptive algorithms in predictive content intelligence engine 130 so that future recommendations to the same or another user are improved in their relevance or utility.

FIG. 10 is a process flow diagram illustrating handling of an outbound email, according to a preferred embodiment of the invention. For outbound emails, or other content objects that are created and edited by a user 142, the process outlined in FIG. 9 is altered in several ways. In step 1000, a new email 800 is opened for editing in an appropriate editing screen of email client applications 351. When email 800 is opened, several steps are then executed in a recommendation plugin (usually displayed as a frame, a popup window, or a dedicated tab within email client application 351). In step 1001, content is fed to predictive content intelligence engine 130 as appropriate. In some embodiments, content (usually, but not necessarily, in the form of text) is fed to engine 130 immediately as it is generated by user 142; in other embodiments content may be fed to engine 130 periodically or when suitable events occur (such as when a paragraph is completed in an editing window). In step 1002, a temporary unique email identifier is generated (for example, by the recommendation plugin; this step is needed typically because until a user either saves an email as a draft or sends the email, a unique email identifier will not be assigned by email server 221), and an email object graph is formed (as described above with reference to step 906 in FIG. 9) using the temporary email identifier. Then, in step 1003, recommendations are generated and refined as the graph object evolves. According to the invention, the graph object evolves because, as text or other content is sent to recommendation plugin, it is (usually automatically, but in some embodiments subject to configurable forwarding options) forwarded to predictive content intelligence engine 130, which performs indexing and expanded social network graph analysis operations (described extensively above) on the graph fragment. As more content is added (and as user 142 interacts with recommendations), this content and information regarding any actions 131 taken are passed to engine 130 and analysis may be refined. Then, in step 1004, a modified send process is used to send email 800 once user 142 has finished editing it and decides to send it (or to save it as a draft). According to a preferred embodiment, the modified send process submits completed email 800 to engine 130 for final analysis before confirming that recommendations 132 are no longer needed. Then, as in the case of inbound emails 800, in step 1005 user actions 131 are recorded to refine current and future recommendations. Finally, in step 1006, when email server 221 generates a unique email identifier for outgoing email 800, the new identifier is used to replace the temporary unique email identifier generated in step 1002, and the finished or sent email 800 is added to expanded social network graph 600 and usually the email object graph is deleted (since all information in it is added to persistent expanded social network graph 600).

In some embodiments, email object graphs are added to expanded social network graph 600 as soon as they are created, or perhaps shortly after; it will be appreciated by one having ordinary skill in the art that no specific sequence is required according to the invention. Also, it should be appreciated that the incoming and outgoing email processes outlined here with reference to FIGS. 9-10 are merely exemplary, and analogous processes may be used for any content object types according to the invention.

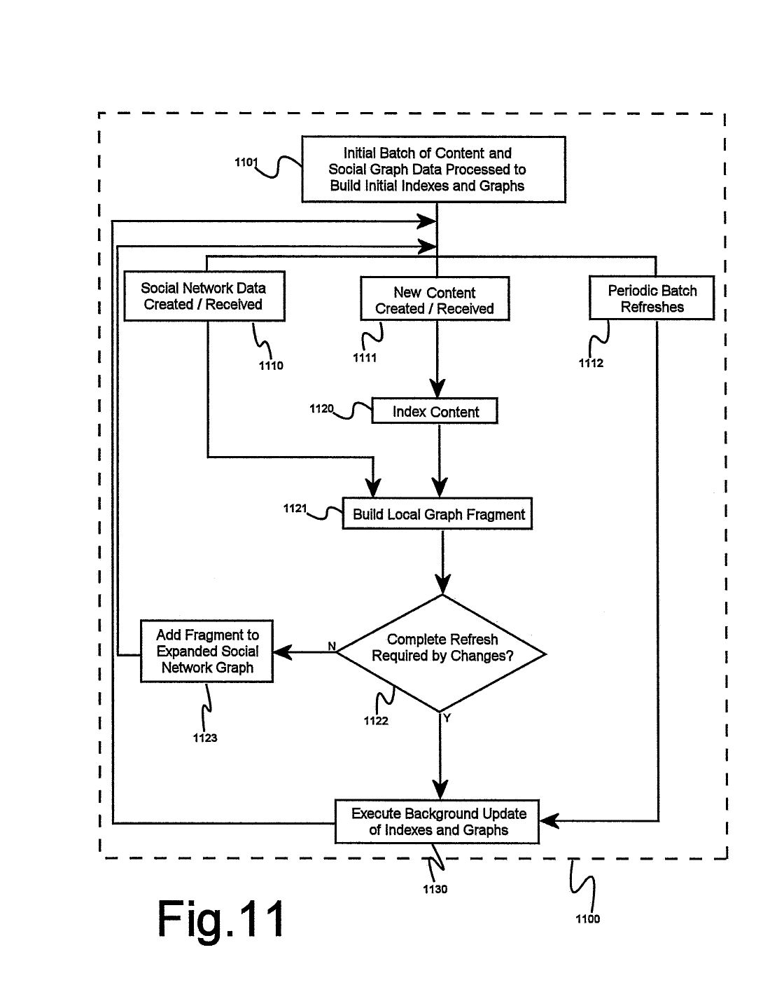

FIG. 11 is a process flow diagram of a method 1100 for managing adaptive contexts, according to a preferred embodiment of the invention. The concept of “adaptive contexts” is relevant, according to the invention, on several time scales. For example, considering short time scales and as disclosed previously, a series of recommendations 132 displayed to a user 142 who is viewing or otherwise interacting with a content object 101 may be modified during an interaction session (a period of time when a user 142 is engaged in interacting with a content object 101), based either on ongoing evaluation of contextual information already considered (for example, if predictive content intelligence engine 130 is configured to generate a list of recommendations 132 based on objects within some specific depth or link number from the subject content object 101 in expanded social network graph 600), or based on actions 131 taken by user 142 while interacting with content object 101 (actions 131 might include selecting or deleting one or more recommendations 132, editing content object 101 by adding for example new material that is determined to relate to a new topic 522, or actively requesting additional information such as by entering a search query). On longer time scales, a corpus of content objects 101 and other objects (people and groups 521, topics 522, domains 523, and so forth) will generally emerge that has been fully indexed and entered into expanded social network graph 600. But, as new objects are analyzed, new domain models 523 and new topics 522 may be added, and for these new entities there will be many objects for which no relationships will have been established, even though actual meaningful relationships may exist. For example, if a new topic of “cryptography” is added to graph 600, there will likely be many people who are present as nodes in graph 600 that have some knowledge of or relationship to cryptography, but for whom no such relationship will be present in graph 600, simply because, when those people were added, cryptography was not an available node to which to link. In general, because of the very high degree of complexity and interconnectedness of a typical graph 600, changes made over time to graph 600 will often lead to situations where many real relationships that are present in the “real world” are not captured in the graph 600, and some process of periodic refreshing of graph 600 is needed. An exemplary process of this sort is illustrated in FIG. 11.

According to an embodiment of the invention, in step 1101, an initial batch of content objects and other social graph data (i.e., ontologies and other domain models, topics, people, etc.) are processed to build an initial set of indexes and at least one expanded social network graph 600. Often this step 1101 is taken when an enterprise or other organization first implements a system 100 or methods according to the invention, and indexes and graphs created in step 1101 can be considered as such an entity's baseline for using the invention (until a large amount of initial data is processed, there will generally not be sufficient content in indexes and graphs to generate useful recommendations, so implementation usually starts with a large scale data import and analysis exercise, represented by step 1101). Once this initialization is completed, steps 1110-1112 typically proceed in parallel as needed. In step 1110, social network data is created or received (or modified or deleted). For example, if a commercial social network service such as Facebook™ is used as a data source for system 100, then as people are added to Facebook™ (or removed), and as relationships between people are added or changed, these changes may be imported into expanded social network graph 600. It is envisioned by the inventors that social graph data will be gathered from many sources, including commercial sources such as Facebook™ and LinkedIn™ (among many other possibilities), organizational data imported for example from a human resources information system of an enterprise, and so forth. As changes are received from these sources (again, “changes” may mean additions, deletions, modifications, or any other changes at all), they are updated in expanded social network graph 600. In parallel, new content objects are received (as when an inbound email is received at an email server) or created (as when a new Word™ document is opened by an author) in step 1111. When content objects are received or modified, in step 1120 they are analyzed by indexing engine 240 to determine for example topics and domains that are present or referred to in the content objects. Step 1121 is carried out normally after each instance of steps 1110 and 1120; in step 1121 a local graph fragment is built in which the newly created or modified object is connected via links to other people, content objects, topics, domains, and so forth as appropriate. This process of building a graph fragment was discussed previously, for example with reference to FIG. 9. Note that, as discussed there, it will typically be the case that local graph fragments are limited in link depth to some manageable level (for example, only 3 levels of link depth may be allowed to ensure computational speed); however, it will generally be true that expanded social network graph 600 will be fully connected (meaning that there will exist at least one path, using edges that link nodes, from any one node to any other node in graph 600), so it is likely that any newly added or modified node (i.e., a person modified in step 1110 or a content object modified in step 1111) will also possess real relationships that will not be present in local graph fragment (because link depth limits may have prevented traversing graph 600 to a point where a relationship would exist). Thus, over time, if only local graph fragments were previously added to expanded social network graph 600, graph 600 would diverge to a greater and greater extent from the true, underlying graph of “real” relationships between the millions of nodes in graph 600. Accordingly, in step 1122 a check is made to determine whether a complete (or indeed perhaps an incomplete but nevertheless more exhaustive than what can be done with limited local graph fragments) refresh of graph 600 is required as a result of changes made. Various tests can be made, according to the invention, to make this determination. For example, a limit on a number of total modifications since a previous refresh cycle could be established; when the limit is reached, step 1122 returns a value of “true”, and otherwise it returns “false”. Or, more specific limits such as a number of new topics or domains introduced, or a number of modifications made to one or more domains, might be used as a parameter to determine whether or not to require a refresh. It will be appreciated by one having ordinary skill in the art that there are an essentially unlimited number of tests that might be applied to make the decisions required in step 1122, any of which (or any combination of which) may be used according to the invention.

If the test in step 1122 returns a value of “false” or an answer of “No”, then in step 1123 the local graph fragment created in step 1121 is added to expanded social network graph 600. On the other hand, if the test returns “true” or “Yes”, then in step 1130 an update of some or all of the indexes and graphs maintained by indexing engine 230 and expanded social network graphing engine 240 is carried out. In a preferred embodiment, updating of graph 600 and associated indexes is carried out as a background task, often using distributed processing (for example, using Map/Reduce techniques known in the art), so that ongoing processing of new content objects and social network changes can take place even as graph 600 is being updated. Once an update is complete, or while it is being conducted in a background mode, processing returns to just below step 1101, and new changes to social networks (step 1110) or content objects (step 1111) are awaited and then processed. In some embodiments, periodic batch refreshes 1112 are conducted in parallel with steps 1110-1111, to ensure that regardless of whether tests specified for step 1122 are satisfied or not, periodically some or all of graphs 600 and associated indexes will be updated. Also, it should be noted that refreshes may be partial rather than total, and that in some embodiments one or more background processes may continually traverse graphs 600 to identify and update previously undetected relationships, or to modify or even delete existing relationships, in a continuous background update mode.

FIG. 12 is an illustration of an exemplary document plugin interface 1200, according to a preferred embodiment of the invention. According to a preferred embodiment of the invention, plugin 1200 is displayed within one or more document management client applications 350, although in some embodiments plugin 1200 may be provided as a standalone application accessible to a user 142 while or even after viewing a content object 101 in a document management client application 350 (that is, plugin 1200 could be provided as a persistent application that, for example, displays a continuously evolved list of recommendations based on a plurality of recent content objects 101 viewed and actions 131 taken by a user 142, and thus providing a more general-purpose assistance to the user 142. Exemplary plugins 1200 may comprise a title bar 1201, one or more contact recommendations 1210, one or more content object recommendations 1220, one or more collaboration or project recommendations 1230, and any number of other recommendations (for example, recommendations that link to a particular public folder in a managed content object store such as SharePoint). Recommendations may be, but need not be, sorted and presented in order of their likely relevance or utility, as judged by relevance engine 524. Contact recommendations 1210 may comprise a photo 1211 or other graphical image representing the contact being recommended (for example, an avatar could be used), a contact name field 121, a “Contact” button 1213 that enables proactive communicative contact with the contact being recommended (for example, clicking button 1213 could pop up an email edit window that is prepopulated with sender and recipient information corresponding to the user 142 viewing the recommendation (sender) and the recommended person who is being contacted (recipient), and possibly an automatically-generated subject line), a contact role data field 1214 (for instance, identifying the contact as an “Account Manager”), and one or more optional social network connection icons or buttons 1215 (for example, well-known Facebook™, Twitter™, and LinkedIn™ icons that are clickable and that will take user 142 to the contact's respective social network home page). Content object recommendations 1220 may comprise an icon 1221 identifying the content object type (email, Word™, Excel™, video file, etc.), one or more attachment preview icons or buttons 1222 (that shows a thumbnail-style image of a representative sample of an attachment or an icon representing the content object type of an attachment, or both), and content-specific metadata such as (for an email; equivalent or other types of data may be used for other content object types, and any data selections shown are merely exemplary in any case) email subject 1223, sent date 1224, attachment title(s) 1225, author(s) 1226, modification date(s) 1227, and the like. Collaboration, project, or public folder recommendations 1230 may comprise a project or other logo 1231, a site icon such as a SharePoint™ logo 1235, a project or folder title 1232, a site owner or project manager name 1233, a source or other hypertext link 1234, and the like. In some embodiments, a “filter bar” 1240 may be provided that allows a user 142 to select a recommendation type and to filter the recommendation list so that only recommendations corresponding to that type are displayed (in some embodiments, more than one recommendation type button may be selected, each acting as a toggle, thus allowing user 142 specify more complex filters such as “show me only Word™ documents and emails”). Recommendation types, represented as clickable icons (which could each have a recognizable logo or a text identifier on it), might include email 1241, chat message 1242, Word™ document 1243, Excel™ document 1244, site icon (for example for SharePoint™) 1245, DropBox folders 1246, and so forth. Many other recommendation types may be used according to the invention, including but not limited to contacts, domains (show only recommendations relevant to a specific domain), topics, and so forth; additional recommendation filter types may be accessed using scroll button 1247 or any other navigation means known in the art. While in some embodiments only a limited number of recommendations may be shown in plugin 1200, others may be rendered viewable either through use of filtering, optional “Next” or “More” buttons, or one or more scroll bar user interface elements 1202, as desired. It will be appreciated that many techniques are known in the art for displaying subsets of a list of items to a user, and for navigating to other subsets of the list, any of which may be used according to the invention.

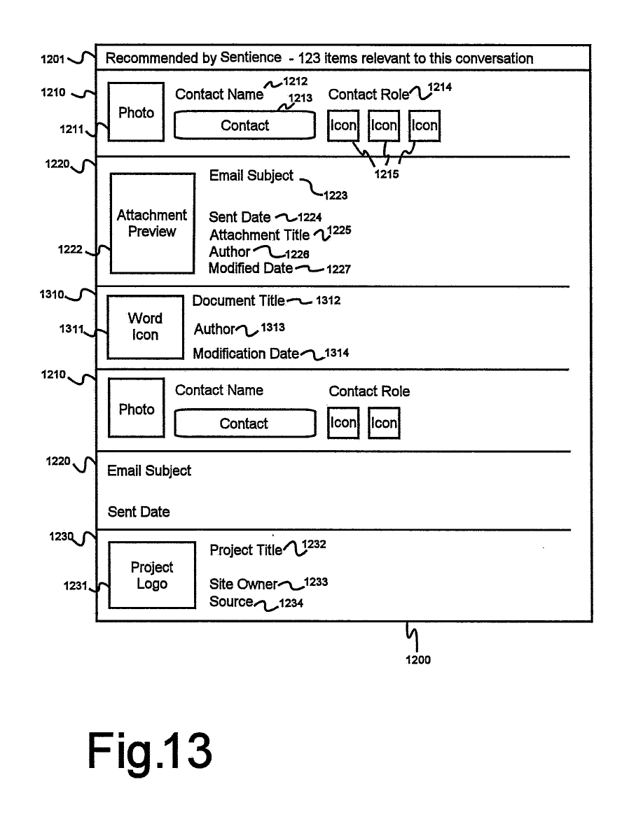

FIG. 13 is an illustration of a further exemplary document plugin interface 1200, according to a preferred embodiment of the invention. According to a preferred embodiment of the invention, content object recommendations 1220 may include an enlarged attachment preview 1222 for easier viewing by a user 142. It should be appreciated that this is purely exemplary, and that content object recommendations 1220 may also comprise an icon or logo 1223 indicating the type of content object being recommended. In a second content object recommendation 1310 it is illustrated that an icon 1311 representing a type of file being recommended (the Word™ document icon illustrated is exemplary) may be displayed to user 142 along with relevant content object data (again, in the illustrated embodiment a Word™ document is purely exemplary and data of any content object types may be used), such as document title(s) 1312, document author(s) 1313, modification date(s) 1314, and the like.

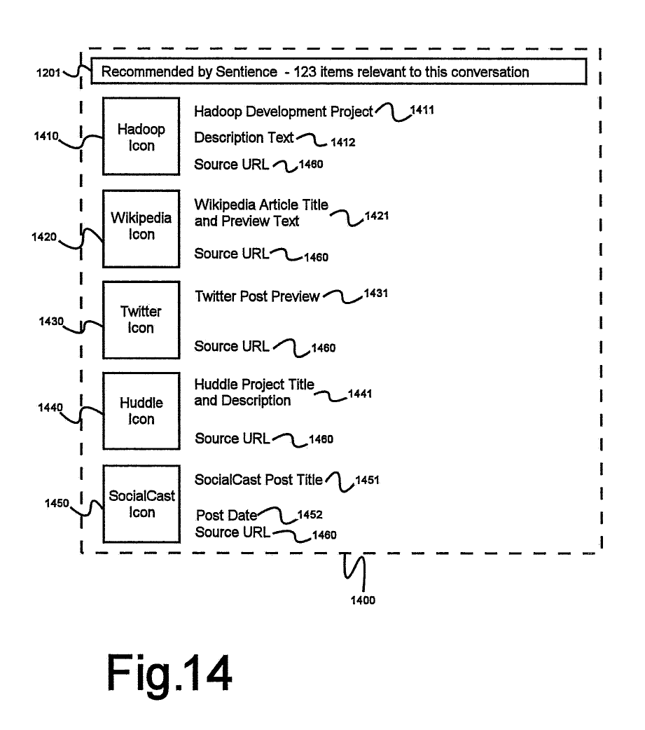

FIG. 14 is an illustration of a further exemplary document plugin interface 1200, according to a preferred embodiment of the invention. In a preferred embodiment, a plugin 1200 may comprise a title bar 1201, and a list or grouping 1400 (a person skilled in the art will appreciate that the specific arrangement is not important and the illustrated configuration is purely exemplary) of recommended web resources, represented as clickable icons (each of which may display a recognizable logo or a text identifier), which might include Hadoop 1410, Wikipedia 1420, Twitter 1430, Huddle 1440, and SocialCast 1450, among others. Many other recommendation types may be used according to the invention, and the illustrated arrangement is purely exemplary. Relevant data for each entry may be displayed alongside the icon, potentially including a Hadoop Project title 1411, Hadoop project description text 1412, Wikipedia article title and preview 1421, Twitter post preview 1431, Huddle project title and description text 1441, Socialcast post title 1451, and a source URL for each recommended resource 1460, among others. A skilled individual will recognize that the type and quantity of relevant data may vary, and the illustrated arrangement is only exemplary. For example, in some embodiments only a single top-ranking suggestion corresponding to each of several types of web resources that may be useful are displayed, as shown in FIG. 14, and each of the resource type icons 1410, 1420, 1430, 1440, 1450 is itself clickable such that, when a user clicks a particular resource type icon, a new list of several relevance-ranked recommendations of that type replaces the list shown in FIG. 14.

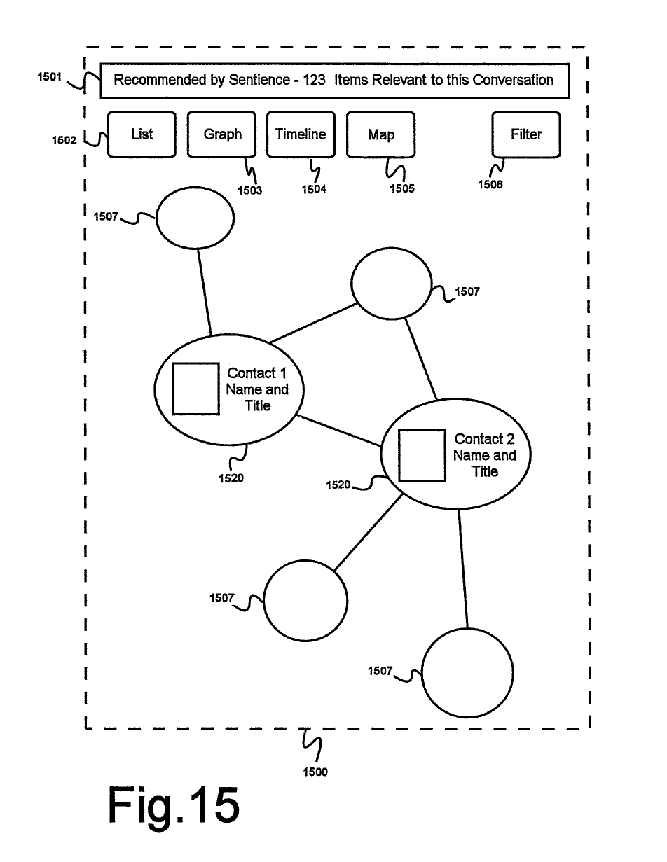

FIG. 15 is an illustration of an exemplary visualization interface 1500 for use by a client, according to an embodiment of the invention. According to a preferred embodiment of the invention, interface 1500 comprises a title bar 1501 and one or more clickable buttons or icons so as to enable rearrangement of interface 1500 as a list 1502, graph 1503 (this is the example shown in FIG. 15), timeline 1504, as a map 1505, as desired, or to apply a filter 1506. In a preferred embodiment, graphic representation of contacts 1520 and projects 1507 are displayed as well as graphic representations of their relationships to each other. The illustrated graphic is purely exemplary, and a skilled individual will appreciate that many possible configurations and arrangements are possible. Thus user 142 is, in some embodiments, provided with means to easily switch between various complementary viewing styles in order to make best use of recommendations 132 provided by system 100.

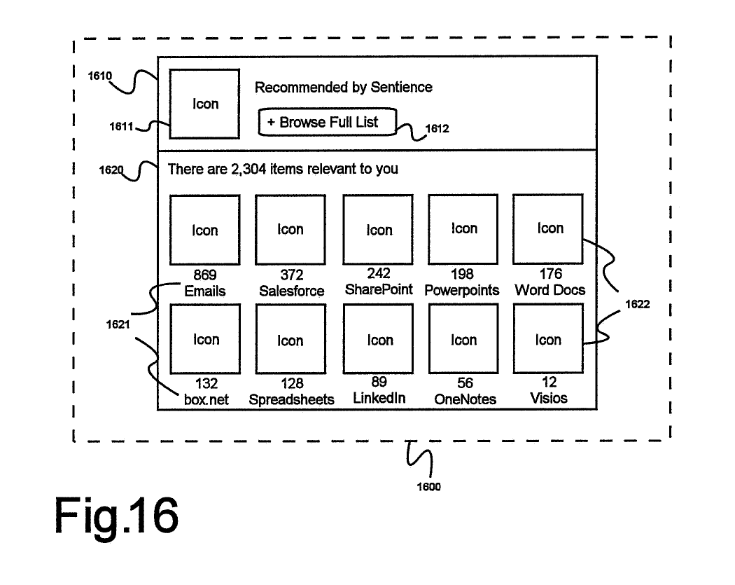

FIG. 16 is an illustration of a summary style user interface view 1600, according to an embodiment of the invention. In a preferred embodiment, interface 1600 is shown to comprise a title frame 1610 including a clickable icon or image 1611 and a clickable button 1612 that allows expansion of the recommendation results displayed in a second frame 1620, displaying one or more recommended items with one or more clickable icons or images 1622 and associated text labels 1621 indicating the results of the search. The arrangement shown is exemplary, and a skilled individual will recognize multiple possible arrangements of data and that not all elements need be present at once in any given embodiment.

It will be appreciated by one having ordinary skill in the art that the use cases described herein are exemplary in nature, and that many additional examples of use cases for the instant invention as claimed are possible. For example, in some embodiments the invention may be used to perform a risk management function. In these embodiments, large collections of content objects of various kinds may be indexed, as described above, and incorporated into expanded social network graph database 255. Then, as content objects are received, created, or modified, they may be analyzed and recommendations may be generated or actions taken based on the content objects' compliance with established rules such as security and legal compliance rules. As an example, a user editing a customer proposal document during a legally mandated “silent period” might inappropriately enter a series of paragraphs disclosing or discussing non-public information, which might constitute a violation of applicable securities laws. When this occurs, real time indexing would also be occurring, and such indexing might identify a topic for the relevant document fragment that corresponds to one of a plurality of legally restricted topics, and a recommendation could be made to the editor of the document to remove or to modify the offending document fragment or section (additionally, alerts may be sent to compliance monitoring personnel, for example to trigger a heightened review of the document to ensure not only that the known offending text was removed, but also that any other possible compliance issues are identified).

In another embodiment of the invention, electronic discovery operations conducted in anticipation of, or as part of, litigation work can be carried out using the invention. According to the embodiment, expanded social network graph database 255 is used as a rich index of content objects that is suitable for identifying content objects (and fragments of content objects) that may be relevant to a particular litigation issue. By combining expanded social network graphing with conventional searching and indexing techniques used in electronic discovery, and by indexing content object fragments as well as whole content objects (so that content objects which are mainly about one topic but have a section that covers another, more litigation-relevant topic, would still be automatically linked to the pending litigation), identifying relevant content objects is accomplished more reliably and often more efficiently as well.

In yet another embodiment of the invention, the entire content object corpus of an enterprise or other organization, or some significant fraction of the entire corpus, can be indexed by systems according to the invention in order to populate an enhanced social network graph database 255. Moreover, continuous indexing of newly added or edited content objects is then conducted, and reindexing of the corpus can also be carried out periodically (which is beneficial, since refinement of an expanded social network graph occurs each time a new content object, person, or topic is added and/or relationships between people, content objects/content object fragments, and topics are modified). With a continuously evolving expanded social network graph, searching for relevant content objects or for people with relevant expertise within an enterprise is greatly enhanced over enterprise search techniques known previously in the art.

Additionally, in some embodiments systems according to the invention are provided as cloud-based platforms that are accessible to and usable by a wide range of users, potentially from any number of distinct enterprises or other organizations. In such embodiments, active rich security models described above are particularly important, as users from various organizations will require access to different items, and with different degrees of freedom, dependent on business needs of the relevant organizations. According to such embodiments, access to capabilities of platforms operating in accordance with the invention may be provided through human user interfaces such as browser-based content object submission and retrieval applications, but also and more generally through any suitable data interface means known in the art. Examples of such data interface means may comprise, but are not limited to, application programming interfaces (APIs), purpose-built and/or customized tools adapted to enable programmatic access for example to expanded social network graph database 255, web services accessed via an application server or a web server, Java remote method invocations, and so forth. Using such access means, third parties may be able, according to some embodiments, to build independent applications that interface with and make use of the capabilities of systems designed in accordance with the invention. In some embodiments, a plurality of such third-party applications may be made available, under suitable commercial terms, via an application store that specializes in providing access to applications designed to make use of the invention.

The skilled person will be aware of a range of possible modifications of the various embodiments described above. Accordingly, the present invention is defined by the claims and their equivalents.

1. A system for enabling contextual computer-mediated recommendations and collaboration recommendations, based on a user's current work, comprising:
a plurality of content collector server computers adapted to interface with a plurality of content management applications;
an indexing server computer;
a database server comprising at least an expanded social network graph database adapted to store an expanded social network graph comprising nodes representing people as well as nodes representing content objects and concepts, and comprising a plurality of edges representing connections between nodes, at least some of the plurality of edges representing connections within the expanded social network graph between nodes representing people and nodes representing either content objects or concepts; and
a predictive content intelligence analysis server computer;
wherein the plurality of content collector server computers receive documents, document fragments, or other content objects from the plurality of content management applications across a network, the indexing server computer indexes the retrieved documents, document fragments, or content objects based on analysis of the textual content within the retrieved documents, document fragments, or content objects, and the expanded social network graph database is modified based at least in part on results of the indexing;
wherein the predictive content intelligence analysis server computer, using at least the results of the indexing and the expanded social network graph database, identifies at least a plurality of other content objects and a plurality of people that are relevant to the received documents, document fragments, or content objects;
wherein of the plurality of other relevant content objects and the plurality of people identified is weighted by a relevance score based at least on a graph distance between the respective relevant content object or person and the received documents, document fragments, or content objects; and
wherein at least a selection of weight-ranked members of the set comprising the plurality of other relevant recommendations of relevant content objects and the plurality of people identified is provided to a user dynamically while the user works within a document or document fragment based upon which the plurality of other content objects and the plurality of people were determined, the selection of weight-ranked members being adjusted substantially immediately as the user makes changes in or moves to semantically distant portions of the document or as additional, more relevant recommendations are identified.

2. The system of claim 1, wherein the predictive content intelligence analysis server computer comprises at least an ontology engine.

3. The system of claim 1, wherein the predictive content intelligence analysis server computer comprises at least a relevance engine.

4. The system of claim 1, wherein the predictive content intelligence analysis server computer comprises at least an ontology engine and a relevance engine.

5. The system of claim 4, wherein a content collector server computer comprises an email interface.

6. The system of claim 5, wherein the email interface is adapted to send identities of or links to the relevant content objects and people to an email client software application as recommendations for use by a user of the email client software application.

7. The system of claim 4, wherein the predictive content intelligence analysis server computer is further adapted to receive via a data network search queries from users, and to provide, in response to the search queries, search results comprising identities of or links to the relevant content objects and people.

8. The system of claim 1, further comprising an active intelligent content storage server computer adapted to determine when a retrieved document, document fragment, or other content object is unmanaged and to thereupon store the unmanaged documents, document fragments, or other content objects such that they may later be reliably retrieved using index information stored in the expanded social network graph database.

9. The system of claim 4, wherein the indexing server computer stores a temporary graph fragment comprising index information derived from a newly-created content fragment, the predictive content intelligence analysis server computer identifies at least a plurality of other content objects and a plurality of people that are relevant based on the temporary graph fragment, and the indexing server computer and the predictive content intelligence analysis server computer iteratively update the temporary graph and the plurality of relevant other content objects and people as the newly-created content fragment is edited; and
wherein when editing of the newly-created content fragment is completed, the temporary graph fragment is added to the expanded social network graph database.

10. A method for enabling contextual computer-mediated recommendations and collaboration within a content item, the method comprising the steps of:
(a) receiving, using a content collector server computer, a document, document fragment, or other content object;
(b) indexing, using an indexing server computer, the document, document fragment, or other content based on analysis of the textual content within the retrieved documents, document fragments, or content objects;
(c) modifying an expanded social network graph database stored and operating on a network-attached database server computer and adapted to store an expanded social network graph comprising nodes representing people as well as nodes representing content objects and concepts, and comprising a plurality of edges representing connections between nodes, at least some of the plurality of edges representing connections within the expanded social network graph between nodes representing people and nodes representing either content objects or concepts using results of the indexing;
(d) identifying, using a predictive content intelligence analysis server computer and the results of the indexing, at least a plurality of other content objects and a plurality of people, the pluralities of other content objects and people relevant to the received document, document fragment, or other content object;
(e) associating a relevance score with each of the plurality of other relevant content objects and the plurality of people identified based at least on a graph distance between the respective relevant content object or person and the received documents, document fragments, or content objects;
(f) providing at least a selection of weight-ranked members of the set comprising the plurality of other relevant recommendations of relevant content objects and the plurality of people identified to a user dynamically while the user works within a document or document fragment based upon which the plurality of other content objects and the plurality of people were determined; and
(g) adjusting the selection of weight-ranked members substantially immediately as the user makes changes in or moves to semantically distant portions of the document or as additional, more relevant recommendations are identified.

11. The method of claim 10, wherein the predictive content intelligence analysis server computer comprises at least an ontology engine.

12. The method of claim 10, wherein the predictive content intelligence analysis server computer comprises at least a relevance engine.

13. The method of claim 10, wherein the predictive content intelligence analysis server computer comprises at least an ontology engine and a relevance engine.

14. The method of claim 13, wherein a content collector server computer comprises an email interface.

15. The method of claim 14, wherein the email interface is adapted to send identities of or links to the relevant content objects and people to an email client software application as recommendations for use by a user of the email client software application.

16. The method of claim 10, further comprising the steps of:
(a1) determining, using an active intelligent content storage database server, if the received document, document fragment, or other content object is unmanaged; and
(a2) if the received document, document fragment, or other content object is unmanaged, storing the unmanaged document, document fragment, or other content object such that it may later be reliably retrieved using index information stored in the expanded social network graph database.

17. A method for enabling contextual computer-mediated recommendations and collaboration within a content object, the method comprising the steps of:
(a) receiving, using a plurality of content collector server, a plurality of documents, document fragments, or other content objects;
(b) indexing the documents, document fragments, or other content objects using an indexing server computer based on analysis of the textual content within the retrieved documents, document fragments, or content objects;
(c) modifying an expanded social network graph database stored database server computer and adapted to store an expanded social network graph comprising nodes representing people as well as nodes representing content objects and concepts, and comprising a plurality of edges representing connections between nodes, at least some of the plurality of edges representing connections within the expanded social network graph between nodes representing people and nodes representing either content objects or concepts using results of the indexing;
(d) receiving, at a predictive content intelligence analysis server computer, a search query from a user;
(e) identifying, using a predictive content intelligence engine analysis server computer and the results of the indexing, at least a plurality of content objects and a plurality of people, the pluralities of content objects and people relevant to the search query;
(f) providing, in response to the search query, search results comprising identities of or links to the relevant content objects and people; and
(g) associating a relevance score with each of the plurality of other relevant content objects and the plurality of people identified based at least on a graph distance between the respective relevant content object or person and the received documents, document fragments, or content objects;
(f) providing at least a selection of weight-ranked members of the set comprising the search results to a user dynamically while the user works within a document or document fragment based upon which the plurality of other content objects and the plurality of people were determined; and
(g) adjusting the selection of weight-ranked members substantially immediately as the user makes changes in or moves to semantically distant portions of the document or as additional, more relevant recommendations are identified.
